(19) United States
(12) Patent Application Publication
(10) Pub. No.: US 2021/0047737 A1
(43) Pub. Date: Feb. 18, 2021

(54) System for Treating A Metal Substrate

(71) Applicant: PPG Industries Ohio, Inc., Cleveland, OH (US)

(72) Inventors: Gordon L. Post, Pittsburgh, PA (US); Michael A. Mayo, Pittsburgh, PA (US); Edward F. Rakiewicz, Gibsonia, PA (US); Kevin A. O'Neil, Boardman, OH (US)

(73) Assignee: PPG Industries Ohio, Inc., Cleveland, OH (US)

(21) Appl. No.: 16/968,632

(22) PCT Filed: Feb. 8, 2019
(86) PCT No.: PCT/US2019/017205

§ 371 Date: Aug. 10, 2020

Related U.S. Application Data
(60) Provisional application No. 62/628,503, filed on Feb. 9, 2018.

(51) Int. Cl. C23C 22/66; C23C 22/83; C23F 1/36; C23G 1/22; C23G 5/032; C09D 7/61; C09D 5/08; C09D 1/00

(52) U.S. Cl. CPC C23C 22/66; C23C 22/83; C23F 1/36; C09D 1/00; C23G 5/032; C09D 7/61; C09D 5/084; C23G 1/22

(57) ABSTRACT

Disclosed is a system for treating a substrate surface. The system includes a conditioner composition and a first pretreatment composition. The conditioner composition comprises a hydroxide source and the first pretreatment composition comprises a magnesium element, a halide element, and an oxidizing agent. Methods of treating a substrate surface using the conditioner composition and the first pretreatment composition also are disclosed. Also disclosed are substrates treated with the system and method.

### CROSS-REFERENCE TO RELATED APPLICATION

This application claims priority to U.S. Provisional Patent Application No. 62/628,503, filed Feb. 9, 2018, entitled “System For Treating A Metal Substrate”, incorporated herein by reference in its entirety.

### FIELD OF THE INVENTION

The present invention relates to systems and methods for treating a metal substrate. The present invention also relates to a coated metal substrate.

### BACKGROUND INFORMATION

The oxidation and degradation of metals used in aerospace, commercial, and private industries are serious and costly problems. To prevent the oxidation and degradation of the metals used in these applications, an inorganic protective coating can be applied to the metal surface. This inorganic protective coating, also referred to as a pretreatment coating, may be the only coating applied to the metal, or the coating can be an intermediate coating to which subsequent coatings are applied.

### SUMMARY OF THE INVENTION

Disclosed herein is a system for treating a metal substrate, comprising: a conditioner composition comprising a hydroxide-containing compound; and a first pretreatment composition comprising a magnesium element, a halide element, and an oxidizing agent.

Also disclosed is a method of treating a substrate, comprising: contacting at least a portion of the substrate with a conditioner composition having a pH greater than 9; and contacting at least a portion of the substrate contacted with the conditioner composition with a first pretreatment composition comprising a magnesium element, a halide element, and an oxidizing agent.

Also disclosed are substrates obtainable by the system and/or method.

### BRIEF DESCRIPTION OF THE FIGURES

FIG. 1 shows images of panels treated according to (A) Example 14, (B) Example 15, (C) Example 16, and (D) Example 17, following 1-day exposure to neutral salt spray in a cabinet operated according to ASTM B117.

FIG. 2 shows (A) average depth total (μm), (B) maximum depth total (μm), and (C) circle equivalent diameter (μm) generated using the Keyence VR3200 3D Measuring Macroscope of panels treated according to Examples 14-17 following 1-day exposure to neutral salt spray in a cabinet operated according to ASTM B117.

FIG. 3 shows images of panels treated according to (A) Example 14, (B) Example 15, (C) Example 16, (D) Example 17, and (E) Example 7, following 7 days exposure to neutral salt spray in a cabinet operated according to ASTM B117.

FIG. 4 shows an XPS depth profile (A) of substrate cleaned by solvent-wipe only and of the substrate treated according to Example 14 and (B) of the substrate treated according to Example 15.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” pretreatment composition, “a” sealing composition, and “an” oxidizing agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed and/or unrecited elements, materials, ingredients and/or method steps. As used herein, “consisting of” is understood in the context of this application to exclude the presence of any unspecified element, ingredient and/or method step. As used herein, “consisting essentially of” is understood in the context of this application to include the specified elements, materials, ingredients and/or method steps “and those that do not materially affect the basic and novel characteristic(s)” of what is being described.

Unless otherwise disclosed herein, the term “substantially free,” when used with respect to the absence of a particular material, means that such material, if present at all in a composition, in a bath containing the composition, and/or in layers formed from and comprising the composition, only is present in a trace amount of 5 ppm or less based on a total weight of the composition or layer(s), as the case may be, excluding any amount of such material that may be present or derived as a result of drag-in, substrate(s), and/or dissolution of equipment). Unless otherwise disclosed herein, the term “essentially free,” when used with respect to the absence of a particular material, means that such material, if present at all in a composition, in a bath containing the composition, and/or in layers formed from and comprising the composition, only is present in a trace amount of 1 ppm or less based on a total weight of the composition or layer(s), as the case may be. Unless otherwise disclosed herein, the term “completely free,” when used with respect to the absence of a particular material, means that such material, if present at all in a composition, in a bath containing the composition, and/or in layers formed from and comprising the composition, is absent from the composition, the bath containing the composition, and/or layers formed from and comprising same (i.e., the composition, bath containing the composition, and/or layers formed from and comprising the composition contain 0 ppm of such material).

As used herein, the terms “on,” “onto,” “applied on,” “applied onto,” “formed on,” “deposited on,” “deposited onto,” mean formed, overlaid, deposited, and/or provided on but not necessarily in contact with the surface. For example, a coating layer “formed over” a substrate does not preclude the presence of one or more other intervening coating layers of the same or different composition located between the formed coating layer and the substrate.

As used herein, a “salt” refers to an ionic compound made up of metal cations and non-metallic anions and having an overall electrical charge of zero. Salts may be hydrated or anhydrous.

As used herein, “aqueous composition” refers to a solution or dispersion in a medium that comprises predominantly water. For example, the aqueous medium may comprise water in an amount of more than 50 wt. %, or more than 70 wt. % or more than 80 wt. % or more than 90 wt. % or more than 95 wt. %, based on the total weight of the medium. The aqueous medium may for example consist substantially of water.

As used herein, “conditioner composition” refers to a composition, i.e., a solution or a dispersion, that, upon contact with a substrate surface, is capable of improving the performance of a subsequently applied pretreatment composition.

As used herein, “pretreatment composition” refers to a composition that is capable of reacting with and chemically altering the substrate surface and binding to it to form a film that affords corrosion protection.

As used herein, “pretreatment bath” refers to an aqueous bath containing the pretreatment composition and that may contain components that are byproducts of the process of contacting a substrate with the pretreatment composition.

As used herein, a “sealing composition” refers to a composition, e.g. a solution or dispersion, that affects a substrate surface or a material deposited onto a substrate surface in such a way as to alter the physical and/or chemical properties of the substrate surface (i.e., the composition affords corrosion protection).

As used herein, the term “Group IA metal” or “Group IA element” refers to an element that is in Group IA of the CAS version of the Periodic Table of the Elements as is shown, for example, in the Handbook of Chemistry and Physics, 63^{rd} edition (1983), corresponding to Group 1 in the actual IUPAC numbering.

As used herein, the term “Group IA metal compound” refers to compounds that include at least one element that is in Group IA of the CAS version of the Periodic Table of the Elements.

As used herein, the term “Group IIIB metal” or “Group IIIB element” refers to yttrium and scandium of the CAS version of the Periodic Table of the Elements as is shown, for example, in the Handbook of Chemistry and Physics, 63^{rd} edition (1983), corresponding to Group 3 in the actual IUPAC numbering. For clarity, “Group IIIB metal” expressly excludes lanthanide series elements.

As used herein, the term “Group IIIB metal compound” refers to compounds that include at least one element that is in group IIIB of the CAS version of the Periodic Table of the Elements as defined above.

As used herein, the term “Group IVB metal” or “Group IVB element” refers to an element that is in group IVB of the CAS version of the Periodic Table of the Elements as is shown, for example, in the Handbook of Chemistry and Physics, 63^{rd} edition (1983), corresponding to Group 4 in the actual IUPAC numbering.

As used herein, the term “Group IVB metal compound” refers to compounds that include at least one element that is in Group IVB of the CAS version of the Periodic Table of the Elements.

As used herein, the term “Group VB metal” or “Group VB element” refers to an element that is in group VB of the CAS version of the Periodic Table of the Elements as is shown, for example, in the Handbook of Chemistry and Physics, 63^{rd} edition (1983), corresponding to Group 5 in the actual IUPAC numbering.

As used herein, the term “Group VB metal compound” refers to compounds that include at least one element that is in Group VB of the CAS version of the Periodic Table of the Elements.

As used herein, the term “Group VIB metal” or “Group VIB element” refers to an element that is in group VIB of the CAS version of the Periodic Table of the Elements as is shown, for example, in the Handbook of Chemistry and Physics, 63^{rd} edition (1983), corresponding to Group 6 in the actual IUPAC numbering.

As used herein, the term “Group VIB metal compound” refers to compounds that include at least one element that is in Group VIB of the CAS version of the Periodic Table of the Elements.

As used herein, the term “lanthanide series elements” refers to elements 57-71 of the CAS version of the Periodic Table of the Elements and includes elemental versions of the lanthanide series elements. In embodiments, the lanthanide series elements may be those which have both common oxidation states of +3 and +4, referred to hereinafter as +3/+4 oxidation states.

As used herein, the term “lanthanide compound” refers to compounds that include at least one of elements 57-71 of the CAS version of the Periodic Table of the Elements.

As used herein, the term “halogen” refers to any of the elements fluorine, chlorine, bromine, iodine, and astatine of the CAS version of the Periodic Table of the Elements, corresponding to Group VIIA of the Periodic Table of Elements.

As used herein, the term “halide” refers to compounds that include at least one halogen.

As used herein, the term “aluminum,” when used in reference to a substrate, refers to substrates made of or comprising aluminum and/or aluminum alloy, and clad aluminum substrates.

As used herein, the term “oxidizing agent,” when used with respect to a component of the pretreatment composition, refers to a chemical which is capable of oxidizing at least one of: a metal present in the substrate which is contacted by the pretreatment composition, a metal cation present in the pretreatment composition, and/or a metal-complexing agent present in the pretreatment composition. As used herein with respect to “oxidizing agent,” the phrase “capable of oxidizing” means capable of removing electrons from an atom or a molecule present in the substrate or the pretreatment composition, as the case may be, thereby decreasing the number of electrons of such atom or molecule.

Pitting corrosion is the localized formation of corrosion by which cavities or holes are produced in a substrate. The term “pit,” as used herein, refers to such cavities or holes resulting from pitting corrosion and, when viewed using the unaided eye, is characterized by (1) a rounded, elongated or irregular appearance when viewed normal to the test panel surface, (2) a “comet-tail”, a line, or a “halo” (i.e., a surface discoloration) emanating from the pitting cavity, and (3) the presence of corrosion byproduct (e.g., white, grayish or black granular, powdery or amorphous material) inside or immediately around the pit. A surface cavity or hole observed with the unaided eye must exhibit at least two of the above characteristics to be considered a corrosion pit. Surface cavities or holes that exhibit only one of these characteristics may require additional analysis before being classified as a corrosion pit, such as by a macroscope, with set minimum parameters of surface area and depth, examples of which are described in detail below. Unless indicated otherwise, as used herein, the term “pit” refers to those pits observed with the unaided eye.

The term “corrosion,” as used herein, refers to the presence of corrosion byproduct (e.g., white, grayish or black granular, powdery or amorphous material) inside or immediately around the pit.

As used herein, a substrate that has fewer pits (whether counted by the unaided eye or by using additional analytical tools such as a macroscope) has better corrosion performance that a substrate that has more pits (counted by the same method), and a substrate that has >100 pits has better corrosion performance than a substrate that has 15% or more surface corrosion. An increase in % surface corrosion indicates poorer corrosion performance.

Unless otherwise disclosed herein, as used herein, the terms “total composition weight”, “total weight of a composition” or similar terms refer to the total weight of all ingredients being present in the respective composition including any carriers and solvents.

Disclosed herein according to the invention is a system for treating a substrate comprising, or consisting essentially of, or consisting of, a conditioner composition and a first pretreatment composition. The conditioner composition may comprise, or consist essentially of, or consist of, a hydroxide-containing compound. The first pretreatment composition may comprise, or consist essentially of, or consist of, a magnesium element, a halogen element, and an oxidizing agent. A system of the present invention may comprise, or may consist essentially of, or may consist of, the conditioner composition and the first pretreatment composition and a cleaning composition, a deoxidizer, a second pretreatment composition, and/or a sealing composition.

As mentioned above, also disclosed herein is a method of treating a substrate comprising, or consisting essentially of, or consisting of: contacting a t least a portion of the substrate surface with a conditioner composition; and contacting at least a portion of the substrate contacted with the conditioner composition with a first pretreatment composition. The conditioner composition may comprise, or consist essentially of, or consist of, a hydroxide-containing compound. The first treatment composition may comprise, or consist essentially of, or consist of, a magnesium element, a halogen element, and an oxidizing agent. A method of the present invention may comprise, or may consist essentially of, or may consist of, contacting at least a portion of the substrate surface with the conditioner composition and the first pretreatment composition and contacting at least a portion of the substrate surface with a cleaning composition, a deoxidizer, a second pretreatment composition, and/or a sealing composition.

As described herein, a substrate treated with the system and/or method of the present invention may comprise, or consist essentially of, or consist of, a film or a layer formed from the first pretreatment composition. Optionally, the substrate may further comprise, or consist essentially of, or consist of, a film or a layer formed from the second pretreatment composition and/or a film or a layer formed from the sealing composition.

Suitable substrates that may be used in the present invention include metal substrates, metal alloy substrates, and/or substrates that have been metallized, such as nickel-plated plastic. The metal or metal alloy can comprise or be steel, aluminum, zinc, nickel, and/or magnesium. For example, the steel substrate could be cold rolled steel, hot rolled steel, electrogalvanized steel, and/or hot dipped galvanized steel. Aluminum alloys of the 1XXX, 2XXX, 3XXX, 4XXX, 5XXX, 6XXX, or 7XXX series as well as clad aluminum alloys also may be used as the substrate. Aluminum alloys may comprise 0.01% by weight copper to 10% by weight copper. Aluminum alloys which are treated may also include castings, such as 1XX.X, 2XX.X, 3XX.X, 4XX.X, 5XX.X, 6XX.X, 7XX.X, 8XX.X, or 9XX.X (e.g.: A356.0). Magnesium alloys of the AZ31B, AZ91C, AM60B, or EV31A series also may be used as the substrate. The substrate used in the present invention may also comprise titanium and/or titanium alloys, zinc and/or zinc alloys, and/or nickel and/or nickel alloys. The substrate may comprise a portion of a vehicle such as a vehicular body (e.g., without limitation, door, body panel, trunk deck lid, roof panel, hood, roof and/or stringers, rivets, landing gear components, and/or skins used on an aircraft) and/or a vehicular frame. As used herein, “vehicle” or variations thereof includes, but is not limited to, civilian, commercial and military aircraft, and/or land vehicles such as cars, motorcycles, and/or trucks.

As mentioned above, the system of the present invention comprises a conditioner composition. The conditioner composition may comprise, for example, a hydroxide-containing compound. The hydroxide-containing compound may be provided as any basic material, including but not limited to water soluble and/or water dispersible bases, such as sodium hydroxide, potassium hydroxide, ammonium hydroxide, or mixtures thereof.

The hydroxide-containing compound of the conditioner composition may further comprise a cation, such as a Group I metal cation, that may be suitable for forming a salt with the hydroxide anion. Non-limiting examples of such Group I metal cations are lithium, sodium, potassium, or combinations thereof.

The conditioner composition may have a pH of at least 9.0, such as at least 12, and may have a pH of no more than 13.5, such as no more than 13.0. The conditioner composition may have a pH of 9.0 to 13.5, such as 12.0 to 13.0. The pH of the conditioner composition may be adjusted using, for example, any acid and/or base as is necessary. The pH of the conditioner composition may be maintained through the inclusion of an acidic material, including water soluble and/or water dispersible acids, such as nitric acid, sulfuric acid, and/or phosphoric acid. The pH of the conditioner composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

The conditioner composition may comprise an aqueous medium and may optionally contain other materials such as nonionic surfactants and auxiliaries. In the aqueous medium, water dispersible organic solvents, for example, alcohols with up to about 8 carbon atoms such as methanol, isopropanol, and the like, may be present; or glycol ethers such as the monoalkyl ethers of ethylene glycol, diethylene glycol, or propylene glycol, and the like. When present, water dispersible organic solvents are typically used in amounts up to about ten percent by volume, based on the total volume of aqueous medium.

Other optional materials included in the conditioner composition include surfactants that function as defoamers or substrate wetting agents. Anionic, cationic, amphoteric, and/or nonionic surfactants may be used. Defoaming surfactants may optionally be present at levels up to 1 weight percent, such as up to 0.1 percent by weight, and wetting agents are typically present at levels up to 2 percent, such as up to 0.5 percent by weight, based on the total weight of the pretreatment composition.

The conditioner composition may comprise a carrier, often an aqueous medium, so that the composition is in the form of a solution or dispersion of the hydroxide anion in the carrier. The solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion when applied to the metal substrate may be at a temperature ranging from 40° F. to 160° F., such as 60° F. to 110° F., such as 70° F. to 90° F. For example, the conditioning process may be carried out at ambient or room temperature. The contact time may be from 5 seconds to 15 minutes, such as 4 minutes to 10 minutes.

According to the present invention, following the contacting with the conditioner composition, the substrate optionally may be air dried at room temperature or may be dried with hot air, for example, by using an air knife, by flashing off the water by brief exposure of the substrate to a high temperature, such as by drying the substrate in an oven at 15° C. to 100° C., such as 20° C. to 90° C., or in a heater assembly using, for example, infrared heat, such as for 10 minutes at 70° C., or by passing the substrate between squeegee rolls. Following the contacting with the conditioner composition, the substrate optionally may be rinsed with tap water, deionized water, and/or an aqueous solution of rinsing agents in order to remove any residue and then optionally may be dried, for example air dried or dried with hot air as described in the preceding sentence. Alternatively, at least a portion of the substrate surface may be wet (i.e., not dried) when contacted with subsequent treatment steps.

The system of the present invention also comprises a first pretreatment composition. The first pretreatment composition may comprise a magnesium element, a halogen element, and an oxidizing agent.

The magnesium element may be present in the first pretreatment composition in an amount of at least 500 ppm (as magnesium cation) based on total weight of the first pretreatment composition, such as at least 1000 ppm, such as at least 1300 ppm, and may be present in an amount of no more than 6000 ppm (as magnesium cation) based on total weight of the first pretreatment composition, such as no more than 3000 ppm, such as no more than 1700 ppm. The magnesium element may be present in the first pretreatment composition in an amount of 500 ppm to 6000 ppm (as magnesium cation) based on total weight of the first pretreatment composition, such as 1000 ppm to 3000 ppm, such as 1300 ppm to 1700 ppm.

The first pretreatment composition may further comprise an anion that may be suitable for forming a salt with the magnesium element, such as a halogen, sulfate, nitrate, acetate, and the like.

The first pretreatment composition may further comprise a halogen element. The halide element may be present in the first pretreatment composition in an amount of at least 1500 ppm (as halogen anion) based on total weight of the first pretreatment composition, such as at least 3000 ppm, such as at least 4,000 ppm, and may be present in an amount of no more than 40,000 ppm (as halogen anion) based on total weight of the first pretreatment composition, such as no more than 18,000 ppm, such as no more than 11,000 ppm. The halogen element may be present in the first pretreatment composition in an amount of 1500 ppm to 40,000 ppm (as halogen anion) based on total weight of the first pretreatment composition, such as 3000 ppm to 18,000 ppm, such as 4000 ppm to 11,000 ppm.

The first pretreatment composition may further comprise a cation suitable for forming a salt with the halogen element, such as metal cations of a lanthanide series element, a Group IA metal, a Group IIA metal, a Group IIIB metal, a Group IVB metal, a Group VB metal, a Group VIB metal, a Group VIIB metal, and/or a Group XII metal, or combinations thereof.

The halogen element may be the same as or different from the halogen that forms a salt with the magnesium cation described above. For example, the magnesium cation and the halide anion may be derived from a single source or alternatively, the magnesium cation and the halide anion may be derived from different sources.

The first pretreatment composition may further comprise an oxidizing agent. Non-limiting examples of the oxidizing agent include peroxides, persulfates, perchlorates, hypochlorite, nitric acid, sparged oxygen, bromates, peroxi-benzoates, ozone, or combinations thereof.

The oxidizing agent may be present in an amount of at least 100 ppm based on total weight of the first pretreatment composition, such as at least 500 ppm, such as at least 750 ppm, and may be present in an amount of no more than 3000 ppm based on total weight of the first pretreatment composition, such as no more than 2000 ppm, such as no more than 1000 ppm. The oxidizing agent may be present in the first pretreatment composition in an amount of 100 ppm to 3000 ppm based on total weight of the first pretreatment composition, such as 500 ppm to 2000 ppm, such as 750 ppm to 1000 ppm.

The first pretreatment composition may have a pH of at least 1.0, such as at least 2.8, such as at least 4.0, such as at least 5.0, and may have a pH of no more than 10.0, such as no more than 9.0, such as no more than 7.0. The first pretreatment composition may have a pH of 1.0 to 7.0, such as 2.8 to 6.5, such as 4.0 to 7.0, such as 4.0 to 9.0, such as 7.0 to 10.0. However, the pH of the first pretreatment composition may vary based on the solubility range of the magnesium cation and the temperature of the first pretreatment composition. The pH of the first pretreatment composition may be adjusted using, for example, any acid and/or base as is necessary. The pH of the first pretreatment composition may be maintained through the inclusion of an acidic material, including water soluble and/or water dispersible acids, such as nitric acid, sulfuric acid, and/or phosphoric acid. The pH of the first pretreatment composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

The system of the present invention optionally may comprise a second pretreatment composition comprising at least one rare earth element. Optionally, the second pretreatment composition may comprise a lanthanide series element such as, for example, cerium, praseodymium, terbium, or combinations thereof. For example, the lanthanide series element used in the second pretreatment composition may be a compound of cerium, praseodymium, terbium, or combinations thereof. Suitable compounds of cerium include, but are not limited to, cerium nitrate, cerium halides, or combinations thereof. Optionally, the second pretreatment composition may comprise a Group IIIB element such as, for example, yttrium, scandium, or combinations thereof. For example, the Group IIIB element used in the second pretreatment composition may be a compound of yttrium, scandium, or a mixture thereof. Suitable compounds of yttrium include, but are not limited to, yttrium halides. In an example, the second pretreatment composition comprises a lanthanide series element and a Group IIIB element.

The rare earth element may be present in the second pretreatment composition in an amount of at least 5 ppm (as rare earth cation), such as at least 150 ppm, such as at least 300 ppm, based on total weight of the second pretreatment composition, and may be present in the second pretreatment composition in an amount of no more than 25,000 ppm (as rare earth cation), such as no more than 12,500 ppm, such as no more than 10,000 ppm, based on total weight of the second pretreatment composition. The rare earth element may be present in the second pretreatment composition in an amount of 5 ppm to 25,000 ppm (as rare earth cation), such as 150 ppm to 12,500 ppm, such as 300 ppm to 10,000 ppm, based on total weight of the second pretreatment composition.

The second pretreatment composition may further comprise an anion that may be suitable for forming a salt with the rare earth element, such as a halogen, a nitrate, a sulfate, a phosphate, a silicate (orthosilicates and metasilicates), a carbonate, an acetate, a hydroxide, a fluoride, and the like.

The anion suitable for forming a salt with the rare earth element may be present in the second pretreatment composition in an amount of at least 2 ppm (calculated as anion) based on total weight of the second pretreatment composition, such as at least 50 ppm, such as at least 150 ppm, such as at least 500 ppm, and may be present in an amount of no more than 25,000 ppm (calculated as anion) based on total weight of the second pretreatment composition, such as no more than 18,500 ppm, such as no more than 5000 ppm, such as no more than 2500 ppm. For example, the anion may be present in the second pretreatment composition in an amount of 5 ppm to 25,000 ppm (calculated as anion) based on total weight of the second pretreatment composition, such as 50 ppm to 18,500 ppm, such as 150 ppm to 4000, such as 500 ppm to 2000 ppm. For example, the anion may be present in the second pretreatment composition in an amount of 2 ppm to 10,000 ppm (calculated as anion) based on total weight of the second pretreatment composition, such as 50 ppm to 5000 ppm, such as 250 ppm to 2500 ppm.

The second pretreatment composition may, in some instances, comprise an oxidizing agent. Non-limiting examples of the oxidizing agent include peroxides, persulfates, perchlorates, hypochlorite, nitric acid, sparged oxygen, bromates, peroxi-benzoates, ozone, or combinations thereof.

The oxidizing agent may be present, if at all, in an amount of at least 100 ppm, such as at least 500 ppm, based on total weight of the second pretreatment composition, and in some instances, may be present in an amount of no more than 13,000 ppm, such as no more than 3000 ppm, based on total weight of the second pretreatment composition. In some instances, the oxidizing agent may be present in the second pretreatment composition, if at all, in an amount of 100 ppm to 13,000 ppm, such as 500 ppm to 3000 ppm, based on total weight of the second pretreatment composition.

According to the present invention, the pH of the second pretreatment composition may be at least 1.0, such as at least 3.0, and may be no more than 4.5, such as no more the 4.0. The pH of the second pretreatment composition may be 1.0 to 4.5, such as 3 to 4, and may be adjusted using, for example, any acid and/or base as is necessary. The pH of the second pretreatment composition may be maintained through the inclusion of an acidic material, including water soluble and/or water dispersible acids, such as nitric acid, sulfuric acid, and/or phosphoric acid. The pH of the second pretreatment composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

Optionally, the first and/or the second pretreatment composition may exclude chromium or chromium-containing compounds. As used herein, the term “chromium-containing compound” refers to materials that include hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate. When a pretreatment composition and/or a coating or a layer formed from the pretreatment composition is substantially free, essentially free, or completely free of chromium, this includes chromium in any form, such as, but not limited to, the hexavalent chromium-containing compounds listed above.

Thus, optionally, the first and/or second pretreatment compositions and/or coatings or layers deposited from the first and/or second pretreatment composition may be substantially free, may be essentially free, and/or may be completely free of one or more of any of the elements or compounds listed in the preceding paragraph. A pretreatment composition and/or coating or layer formed from the pretreatment composition that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the pretreatment composition; in the case of chromium, this may further include that the element or compounds thereof are not present in the pretreatment compositions and/or coatings or layers formed from the pretreatment composition in such a level that it causes a burden on the environment. The term “substantially free” means that the pretreatment compositions and/or coating or layers formed from the pretreatment composition contain less than 10 ppm of any or all of the elements or compounds listed in the preceding paragraph, based on total weight of the composition or the layer, respectively, if any at all. The term “essentially free” means that the pretreatment compositions and/or coatings or layers formed from the pretreatment composition contain less than 1 ppm of any or all of the elements or compounds listed in the preceding paragraph, if any at all. The term “completely free” means that the pretreatment compositions and/or coatings or layers formed from the pretreatment composition contain less than 1 ppb of any or all of the elements or compounds listed in the preceding paragraph, if any at all.

According to the present invention, the first and/or the second pretreatment composition may, in some instances, exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as ortho phosphate, pyrophosphate, metaphosphate, tripolyphosphate, organophosphonates, and the like, and can include, but are not limited to, monovalent, divalent, or trivalent cations such as: sodium, potassium, calcium, zinc, nickel, manganese, aluminum and/or iron. When a pretreatment composition and/or a layer or coating comprising the same is substantially free, essentially free, or completely free of phosphate, this includes phosphate ions or compounds containing phosphate in any form.

Thus, the first and/or the second pretreatment composition and/or layers deposited from the same may be substantially free, or in some cases may be essentially free, or in some cases may be completely free, of one or more of any of the ions or compounds listed in the preceding paragraph. A pretreatment composition and/or layers deposited from the same that is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition; this may further include that phosphate is not present in the pretreatment compositions and/or layers deposited from the same at such a level that they cause a burden on the environment. The term “substantially free” means that the pretreatment compositions and/or layers deposited from the same contain less than 5 ppm of any or all of the phosphate anions or compounds listed in the preceding paragraph, based on total weight of the composition or the layer, respectively, if any at all. The term “essentially free” means that the pretreatment compositions and/or layers comprising the same contain less than 1 ppm of any or all of the phosphate anions or compounds listed in the preceding paragraph. The term “completely free” means that the pretreatment compositions and/or layers comprising the same contain less than 1 ppb of any or all of the phosphate anions or compounds listed in the preceding paragraph, if any at all.

The first and/or second pretreatment composition may comprise an aqueous medium and may optionally contain other materials such as nonionic surfactants and auxiliaries conventionally used in the art of pretreatment compositions. In the aqueous medium, water dispersible organic solvents, for example, alcohols with up to about 8 carbon atoms such as methanol, isopropanol, and the like, may be present; or glycol ethers such as the monoalkyl ethers of ethylene glycol, diethylene glycol, or propylene glycol, and the like. When present, water dispersible organic solvents are typically used in amounts up to about ten percent by volume, based on the total volume of aqueous medium.

Other optional materials included in the first and/or second pretreatment composition include surfactants that function as defoamers or substrate wetting agents. Anionic, cationic, amphoteric, and/or nonionic surfactants may be used. Defoaming surfactants may optionally be present at levels up to 1 weight percent, such as up to 0.1 percent by weight, and wetting agents are typically present at levels up to 2 percent, such as up to 0.5 percent by weight, based on the total weight of the pretreatment composition.

Optionally, the first and/or second pretreatment composition and/or films deposited or formed therefrom may further comprise silicon in amounts of at least 10 ppm, based on total weight of the pretreatment composition, such as at least 20 ppm, such as at least 50 ppm. The first and/or second pretreatment composition and/or films deposited or formed therefrom may comprise silicon in amounts of less than 500 ppm, based on total weight of the pretreatment composition, such as less than 250 ppm, such as less than 100 ppm. The first and/or second pretreatment composition and/or films deposited or formed therefrom may comprise silicon in amounts of 10 ppm to 500 ppm, based on total weight of the pretreatment composition, such as 20 ppm to 250 ppm, such as 50 ppm to 100 ppm. Alternatively, the first and/or second pretreatment composition of the present invention and/or films deposited or formed therefrom may be substantially free or completely free of silicon.

The first and/or second pretreatment composition may comprise a carrier, often an aqueous medium, so that the composition is in the form of a solution or dispersion of the metal cation and/or the metal cation-containing compound in the carrier. The solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion when applied to the metal substrate may be at a temperature ranging from 40° F. to 160° F., such as 60° F. to 110° F., such as 70° F. to 90° F. For example, the pretreatment process may be carried out at ambient or room temperature. The contact time may be from 5 seconds to 15 minutes, such as 4 minutes to 10 minutes.

According to the present invention, following the contacting with the first and/or second pretreatment composition, the substrate optionally may be air dried at room temperature or may be dried with hot air, for example, by using an air knife, by flashing off the water by brief exposure of the substrate to a high temperature, such as by drying the substrate in an oven at 15° C. to 100° C., such as 20° C. to 90° C., or in a heater assembly using, for example, infrared heat, such as for 10 minutes at 70° C., or by passing the substrate between squeegee rolls. Following the contacting with the pretreatment composition, the substrate optionally may be rinsed with tap water, deionized water, and/or an aqueous solution of rinsing agents in order to remove any residue and then optionally may be dried, for example air dried or dried with hot air as described in the preceding sentence. Alternatively, at least a portion of the substrate surface may be wet (i.e., not dried) when contacted with subsequent treatment steps.

At least a portion of the substrate surface may be cleaned and/or deoxidized prior to contacting at least a portion of the substrate surface with the conditioner composition described above, in order to remove grease, dirt, and/or other extraneous matter. At least a portion of the surface of the substrate may be cleaned by physical and/or chemical means, such as mechanically abrading the surface and/or cleaning/degreasing the surface with commercially available alkaline or acidic cleaning agents that are well known to those skilled in the art. Examples of alkaline cleaners suitable for use in the present invention include Chemkleen™ 166HP, 166M/C, 177, 490MX, 2010LP, and Surface Prep 1 (SP1), Ultrax 32, Ultrax 97, Ultrax 29, and Ultrax92D, each of which are commercially available from PPG Industries, Inc. (Cleveland, Ohio), and any of the DFM Series, RECC 1001, and 88X1002 cleaners commercially available from PRC-DeSoto International (Sylmar, Calif.), and Turco 4215-NCLT and Ridolene commercially available from Henkel Technologies (Madison Heights, Mich.). Such cleaners are often preceded or followed by a water rinse, such as with tap water, distilled water, or combinations thereof.

As mentioned above, at least a portion of the substrate surface may be deoxidized, mechanically and/or chemically. As used herein, the term “deoxidize” means at least partial removal of the oxide layer found on the surface of the substrate. As used herein with respect to removal of the oxide layer, the term “at least partial” means removal as determined using a handful of analytical techniques including, but not limited to XPS (x-ray photoelectron spectroscopy) depth profiling or TEM (transmission electron microscopy). For example, transmission electron microscope (TEM) images may be captured from a panel by any protocol known to those skilled in the art, including using an FEI Helios Nanolab 660 Dual Beam focused ion beam (FIB) using the ‘in situ lift-out’ technique (R. M Langford, “In situ lift-out using a FIB-SEM system”, Micron v.35, pp. 607-611, 2004). A layer of gold (Au) and then a layer of carbon (C) may be deposited using the FIB over the surface of the sample to prevent damage during the subsequent Ga+ ion beam milling. A thin section, roughly 5 microns wide and 5 microns deep, may be milled out from the surface of the sample using a 30 kV ion beam and attached to a TEM grid in-situ using a micromanipulator. This section may be then thinned further with ion beam until the final thickness was approximately 100 nm. For final cleaning of the surface, an ion beam energy of 2 kV may be used. TEM and scanning transmission electron microscopy (STEM) may be performed using, for example, a FEI Talos F200X field-emission TEM at an accelerating voltage of 200 kV. The magnification of the microscope may be calibrated using a cross grating replica standard from Agar Scientific. (Cross Grating Replica, AGS106, diffraction line gratings spacing 462.9 nm, http://www.agarscientific.com/diffraction-grating-replicas.html). HAADF-STEM (high angle annular dark field) images may be collected from the sample which results in an image that primarily shows mass contrast approximately proportional to the square of the atomic number of the elements present.

Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, Mich.), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating. The skilled artisan will select a temperature range of the solution or dispersion, when applied to the metal substrate, based on etch rates, for example, at a temperature ranging from 50° F. to 150° F. (10° C. to 66° C.), such as from 70° F. to 130° F. (21° C. to 54° C.), such as from 80° F. to 120° F. (27° C. to 49° C.). The contact time may be from 30 seconds to 20 minutes, such as 1 minute to 15 minutes, such as 90 seconds to 12 minutes, such as 3 minutes to 9 minutes.

Following the cleaning and/or deoxidizing step(s), the substrate optionally may be rinsed with tap water, deionized water, and/or an aqueous solution of rinsing agents in order to remove any residue. The wet substrate surface may be treated with a pretreatment composition (described above) and/or a sealing composition (described below), or the substrate may be dried prior to treating the substrate surface, such as air dried, for example, by using an air knife, by flashing off the water by brief exposure of the substrate to a high temperature, such as 15° C. to 100° C., such as 20° C. to 90° C., or in a heater assembly using, for example, infrared heat, such as for 10 minutes at 70° C., or by passing the substrate between squeegee rolls.

As mentioned above, the system of the present invention optionally may comprise a sealing composition. The sealing composition may comprise a lithium element. The lithium element may be in the form of a lithium salt. In addition, the sealing composition also may further comprise at least one Group IA element other than lithium, a Group VB element, and/or Group VIB element. The at least one Group IA element other than lithium, the Group VB element, and/or Group VIB element may be in the form of a salt. Nonlimiting examples of anions suitable for forming a salt with the lithium, Group IA elements other than lithium, Group VB elements, and/or Group VIB elements include carbonates, hydroxides, nitrates, halogens, sulfates, phosphates and silicates (e.g., orthosilicates and metasilicates) such that the metal salt may comprise a carbonate, an hydroxide, a nitrate, a halide, a sulfate, a phosphate, a silicate (e.g., orthosilicate or metasilicate), a permanganate, a chromate, a vanadate, a molybdate, and/or a perchlorate.

According to the present invention, the metal salts of the sealing composition (i.e., the salts of lithium, Group IA elements other than lithium, Group VB elements, and/or Group VIB elements) each may be present in the sealing composition in an amount of at least 25 ppm, such as at least 150 ppm, such as at least 500 ppm (calculated as total compound) based on total weight of the sealing composition, and in some instances, no more than 30000 ppm, such as no more than 2000 ppm, such as no more than 1750 ppm (calculated as total compound) based on total weight of the sealing composition. According to the present invention, the metal salts of the sealing composition (i.e., the salts of lithium, Group IA elements other than lithium, Group VB elements, and/or Group VIB elements) each may be present in the sealing composition in an amount of 25 ppm to 30000 ppm, such as 150 ppm to 2000 ppm, such as 500 ppm to 1750 (calculated as total compound) based on total weight of the sealing composition.

According to the present invention, the lithium cation, the Group IA element other than lithium, the Group VB element, and the Group VIB element each may be present in the sealing composition in an amount of at least 5 ppm, such as at least 50 ppm, such as at least 150 ppm, such as at least 250 ppm (calculated as cation) based on total weight of the sealing composition, and in some instances, may be present in an amount of no more than 5500 ppm, such as no more than 1200 ppm, such as no more than 1000 ppm, such as no more than 500 ppm, (calculated as cation) based on total weight of the sealing composition. In some instances, according to the present invention, the lithium element, the Group IA element other than lithium, the Group VB element, and the Group VIB element each may be present in the sealing composition in an amount of 5 ppm to 5500 ppm, such as 50 ppm to 1000 ppm, (calculated as cation) based on total weight of the sealing composition, such as 150 ppm to 500 ppm.

The lithium salt may comprise an inorganic lithium salt, an organic lithium salt, or combinations thereof. The anion and the cation of the lithium salt both may be soluble in water. According to the present invention, for example, the lithium salt may have a solubility constant in water at a temperature of 25° C. (K; 25° C.) of at least 1×10⁻¹, such as least 1×10⁻⁴, and in some instances, may be no more than 5×10⁺². The lithium salt may have a solubility constant in water at a temperature of 25° C. (K; 25° C.) of 1×10⁻¹¹ to 5×10⁻², such as 1×10⁻⁴ to 5×10⁻². As used herein, “solubility constant” means the product of the equilibrium concentrations of the ions in a saturated aqueous solution of the respective lithium salt. Each concentration is raised to the power of the respective coefficient of ion in the balanced equation. The solubility constants for various salts can be found in the Handbook of Chemistry and Physics.

The sealing composition may an include oxidizing agent, such as hydrogen peroxide, persulfates, perchlorates, sparged oxygen, bromates, peroxi-benzoates, ozone, and the like, or combinations thereof. For example, the sealing composition may comprise 0.1 wt % to 15 wt % of an oxidizing agent based on total weight of the sealing composition, such as 2 wt % to 10 wt %, such as 6 wt % to 8 wt %. Alternatively, the sealing composition may be substantially free, or essentially free, or completely free, of an oxidizing agent.

The sealing composition optionally may exclude Group IIA elements or Group IIA metal-containing compounds, including but not limited to calcium. Non-limiting examples of such materials include Group IIA metal hydroxides, Group IIA metal nitrates, Group IIA metal halides, Group IIA metal sulfamates, Group IIA metal sulfates, Group IIA carbonates and/or Group IIA metal carboxylates. When a sealing composition and/or a coating or a layer formed from the sealing composition is substantially free, essentially free, or completely free of a Group IIA metal cation, this includes Group IIA metal cations in any form, such as, but not limited to, the Group IIA metal-containing compounds listed above.

The sealing composition optionally may exclude chromium or chromium-containing compounds. As used herein, the term “chromium-containing compound” refers to materials that include hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate. When a sealing composition and/or a coating or a layer formed from the sealing composition is substantially free, essentially free, or completely free of chromium, this includes chromium in any form, such as, but not limited to, the hexavalent chromium-containing compounds listed above.

Thus, optionally, the sealing compositions and/or coatings or layers formed from the sealing composition may be substantially free, may be essentially free, and/or may be completely free of one or more of any of the elements or compounds listed in the preceding paragraph. A sealing composition and/or coating or layer formed from the sealing composition that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the sealing composition; in the case of chromium, this may further include that the element or compounds thereof are not present in the sealing compositions and/or coatings or layers formed from the sealing composition in such a level that it causes a burden on the environment. The term “substantially free” means that the sealing compositions and/or coating or layers formed from the sealing composition contain less than 10 ppm of any or all of the elements or compounds listed in the preceding paragraph, based on total weight of the composition or the layer formed from the sealing composition, if any at all. The term “essentially free” means that the sealing compositions and/or coatings or layers formed from the sealing composition contain less than 1 ppm of any or all of the elements or compounds listed in the preceding paragraph, if any at all. The term “completely free” means that the sealing compositions and/or coatings or layers formed from the sealing composition contain less than 1 ppb of any or all of the elements or compounds listed in the preceding paragraph, if any at all.

The sealing composition optionally may exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as ortho phosphate, pyrophosphate, metaphosphate, tripolyphosphate, organophosphonates, and the like, and can include, but are not limited to, monovalent, divalent, or trivalent cations such as: sodium, potassium, calcium, zinc, nickel, manganese, aluminum and/or iron. When a composition and/or a layer or coating comprising the same is substantially free, essentially free, or completely free of phosphate, this includes phosphate ions or compounds containing phosphate in any form.

Thus, sealing composition and/or layers deposited from the same may be substantially free, or in some cases may be essentially free, or in some cases may be completely free, of one or more of any of the ions or compounds listed in the preceding paragraph. A sealing composition and/or layers deposited from the same that is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition; this may further include that phosphate is not present in the sealing compositions and/or layers deposited from the same at such a level that they cause a burden on the environment. The term “substantially free” means that the sealing compositions and/or layers deposited from the same contain less than 5 ppm of any or all of the phosphate anions or compounds listed in the preceding paragraph, based on total weight of the composition or the layer, respectively, if any at all. The term “essentially free” means that the sealing compositions and/or layers comprising the same contain less than 1 ppm of any or all of the phosphate anions or compounds listed in the preceding paragraph. The term “completely free” means that the sealing compositions and/or layers comprising the same contain less than 1 ppb of any or all of the phosphate anions or compounds listed in the preceding paragraph, if any at all.

The sealing composition optionally may exclude fluoride or fluoride sources. As used herein, “fluoride sources” include monofluorides, bifluorides, fluoride complexes, and mixtures thereof known to generate fluoride ions. When a composition and/or a layer or coating comprising the same is substantially free, essentially free, or completely free of fluoride, this includes fluoride ions or fluoride sources in any form, but does not include unintentional fluoride that may be present in a bath as a result of, for example, carry-over from prior treatment baths in the processing line, municipal water sources (e.g.: fluoride added to water supplies to prevent tooth decay), fluoride from a pretreated substrate, or the like. That is, a bath that is substantially free, essentially free, or completely free of fluoride, may have unintentional fluoride that may be derived from these external sources, even though the composition used to make the bath prior to use on the processing line was substantially free, essentially free, or completely free of fluoride.

For example, the sealing composition may be substantially free of any fluoride-sources, such as ammonium and alkali metal fluorides, acid fluorides, fluoroboric, fluorosilicic, fluorotitanic, and fluorozirconic acids and their ammonium and alkali metal salts, and other inorganic fluorides, nonexclusive examples of which are: zinc fluoride, zinc aluminum fluoride, titanium fluoride, zirconium fluoride, nickel fluoride, ammonium fluoride, sodium fluoride, potassium fluoride, and hydrofluoric acid, as well as other similar materials known to those skilled in the art.

Fluoride present in the sealing composition that is not bound to metals ions such as Group IVB metal ions, or hydrogen ion, defined herein as “free fluoride,” may be measured as an operational parameter in the sealing composition bath using, for example, an Orion Dual Star Dual Channel Benchtop Meter equipped with a fluoride ion selective electrode (“ISE”) available from Thermoscientific, the Symphony® Fluoride Ion Selective Combination Electrode supplied by VWR International, or similar electrodes. See, e.g., Light and Cappuccino, Determination of fluoride in toothpaste using an ion-selective electrode, J. Chem. Educ., 52:4, 247-250, April 1975. The fluoride ISE may be standardized by immersing the electrode into solutions of known fluoride concentration and recording the reading in millivolts, and then plotting these millivolt readings in a logarithmic graph. The millivolt reading of an unknown sample can then be compared to this calibration graph and the concentration of fluoride determined. Alternatively, the fluoride ISE can be used with a meter that will perform the calibration calculations internally and thus, after calibration, the concentration of the unknown sample can be read directly.

Fluoride ion is a small negative ion with a high charge density, so in aqueous solution it is frequently complexed with metal ions having a high positive charge density, such as Group IVB metal ions, or with hydrogen ion. Fluoride anions in solution that are ionically or covalently bound to metal cations or hydrogen ion are defined herein as “bound fluoride.” The fluoride ions thus complexed are not measurable with the fluoride ISE unless the solution they are present in is mixed with an ionic strength adjustment buffer (e.g., citrate anion or EDTA) that releases the fluoride ions from such complexes. At that point (all of) the fluoride ions are measurable by the fluoride ISE, and the measurement is known as “total fluoride”. Alternatively, the total fluoride can be calculated by comparing the weight of the fluoride supplied in the sealer composition by the total weight of the composition.

The sealing composition optionally may be substantially free, or essentially free, or completely free, of cobalt ions or cobalt-containing compounds. As used herein, “cobalt-containing compounds” include compounds, complexes or salts containing the element cobalt such as, for example, cobalt sulfate, cobalt nitrate, cobalt carbonate and cobalt acetate. When a composition and/or a layer or coating comprising the same is substantially free, essentially free, or completely free of cobalt, this includes cobalt ions or compounds containing cobalt in any form.

The sealing composition optionally may be substantially free, or essentially free, or completely free, of vanadium ions or vanadium-containing compounds. As used herein, “vanadium-containing compounds” include compounds, complexes or salts containing the element vanadium such as, for example, vanadates and decavanadates that include counterions of alkali metal or ammonium cations, including, for example, sodium ammonium decavanadate. When a composition and/or a layer or coating comprising the same is substantially free, essentially free, or completely free of vanadium, this includes vanadium ions or compounds containing vanadium in any form.

The sealing composition may optionally further contain an indicator compound, so named because it indicates, for example, the presence of a chemical species, such as a metal ion, the pH of a composition, and the like. An “indicator”, “indicator compound”, and like terms as used herein refer to a compound that changes color in response to some external stimulus, parameter, or condition, such as the presence of a metal ion, or in response to a specific pH or range of pHs.

The indicator compound used according to the present invention can be any indicator known in the art that indicates the presence of a species, a particular pH, and the like. For example, a suitable indicator may be one that changes color after forming a metal ion complex with a particular metal ion. The metal ion indicator is generally a highly conjugated organic compound. A “conjugated compound” as used herein, and as will be understood by those skilled in the art, refers to a compound having two double bonds separated by a single bond, for example two carbon-carbon double bonds with a single carbon-carbon bond between them. Any conjugated compound can be used according to the present invention.

Similarly, the indicator compound can be one in which the color changes upon change of the pH; for example, the compound may be one color at an acidic or neutral pH and change color in an alkaline pH, or vice versa. Such indicators are well known and widely commercially available. An indicator that “changes color upon transition from a first pH to a second pH” (i.e., from a first pH to a second pH that is more or less acidic or alkaline) therefore has a first color (or is colorless) when exposed to a first pH and changes to a second color (or goes from colorless to colored) upon transition to a second pH (i.e., one that is either more or less acidic or alkaline than the first pH). For example, an indicator that “changes color upon transition to a more alkaline pH (or less acidic pH) goes from a first color/colorless to a second color/color when the pH transitions from acidic/neutral to alkaline. For example, an indicator that “changes color upon transition to a more acidic pH (or less alkaline pH) goes from a first color/colorless to a second color/color when the pH transitions from alkaline/neutral to acidic.

Non-limiting examples of such indicator compounds include methyl orange, xylenol orange, catechol violet, bromophenol blue, green and purple, eriochrome black T, Celestine blue, hematoxylin, calmagite, gallocyanine, and combinations thereof. Optionally, the indicator compound may comprise an organic indicator compound that is a metal ion indicator. Nonlimiting examples of indicator compounds include those found in Table 1. Fluorescent indicators, which will emit light in certain conditions, can also be used according to the present invention, although the use of a fluorescent indicator also may be specifically excluded. That is, alternatively, conjugated compounds that exhibit fluorescence are specifically excluded. As used herein, “fluorescent indicator” and like terms refer to compounds, molecules, pigments, and/or dyes that will fluoresce or otherwise exhibit color upon exposure to ultraviolet or visible light. To “fluoresce” will be understood as emitting light following absorption of shorter wavelength light or other electromagnetic radiation. Examples of such indicators, often referred to as “tags,” include acridine, anthraquinone, coumarin, diphenylmethane, diphenylnaphthlymethane, quinoline, stilbene, triphenylmethane, anthracine and/or molecules containing any of these moieties and/or derivatives of any of these such as rhodamines, phenanthridines, oxazines, fluorones, cyanines and/or acridines.

TABLE 1

| Compound | Structure | CAS Reg. No. |
|---|---|---|
| Catechol Violet Synonyms: Catecholsulfonphthalein; Pyrocatecholsulfonephthalein; Pyrocatechol Violet | 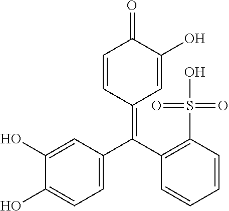 [SMILES: O=C1C=C/C(=C(\c2ccc(O)c(O)c2)c2ccccc2S(=O)(=O)O)C=C1O] | 115-41-3 |
| Xylenol Orange Synonym: 3,3′-Bis[N,N- bis(carboxymethyl)aminomethyl]- ο-cresolsulfonephthalein tetrasodium salt | 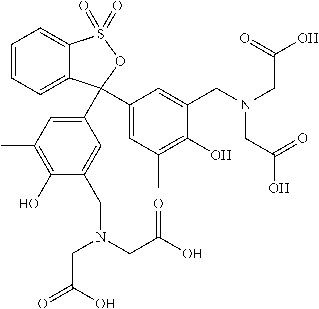 [SMILES: Cc1cc(C2(c3cc(C)c(O)c(CN(CC(=O)O)CC(=O)O)c3)OS(=O)(=O)c3ccccc32)cc(CN(CC(=O)O)CC(=O)O)c1O] | 3618-43-7 |

The conjugated compound useful as indicator may for example comprise catechol violet, as shown in Table 1. Catechol violet (CV) is a sulfone phthalein dye made from condensing two moles of pyrocatechol with one mole of o-sulfobenzoic acid anhydride. It has been found that CV has indicator properties and when incorporated into compositions having metal ions, it forms complexes, making it useful as a complexiometric reagent. As the composition containing the CV chelates metal ions coming from the metal substrate (i.e., those having bi- or higher valence), a generally blue to blue-violet color is observed.

Xylenol orange, as shown in Table 1 may likewise be employed in the compositions according to the present invention. It has been found that xylenol orange has metal ion (i.e., those having bi- or higher valence) indicator properties and when incorporated into compositions having metal ions, it forms complexes, making it useful as a complexiometric reagent. As the composition containing the xylenol orange chelates metal ions, a solution of xylenol orange turns from red to a generally blue color.

The indicator compound may be present in the sealing composition in an amount of at least 0.01 g/1000 g sealing composition, such as at least 0.05 g/1000 g sealing composition, and in some instances, no more than 3 g/1000 g sealing composition, such as no more than 0.3 g/1000 g sealing composition. The indicator compound may be present in the sealing composition in an amount of 0.01 g/1000 g sealing composition to 3 g/1000 g sealing composition, such as 0.05 g/1000 g sealing composition to 0.3 g/1000 g sealing composition.

The indicator compound changing color in response to a certain external stimulus provides a benefit when using the sealing composition in that it can serve, for example, as a visual indication that a substrate has been treated with the composition. For example, a sealing composition comprising an indicator that changes color when exposed to a metal ion that is present in the substrate will change color upon complexing with metal ions in that substrate; this allows the user to see that the substrate has been contacted with the composition. Similar benefits can be realized by depositing an alkaline or acid layer on a substrate and contacting the substrate with a composition of the present invention that changes color when exposed to an alkaline or acidic pH.

Optionally, the sealing composition may further comprise a nitrogen-containing heterocyclic compound. The nitrogen-containing heterocyclic compound may include cyclic compounds having 1 nitrogen atom, such as pyrroles, and azole compounds having 2 or more nitrogen atoms, such as pyrazoles, imidazoles, triazoles, tetrazoles and pentazoles, 1 nitrogen atom and 1 oxygen atom, such as oxazoles and isoxazoles, or 1 nitrogen atom and 1 sulfur atom, such as thiazoles and isothiazoles. Nonlimiting examples of suitable azole compounds include 2,5-dimercapto-1,3,4-thiadiazole (CAS: 1072-71-5), 1H-benzotriazole (CAS: 95-14-7), 1H-1,2,3-triazole (CAS: 288-36-8), 2-amino-5-mercapto-1,3,4-thiadiazole (CAS: 2349-67-9), also named 5-amino-1,3,4-thiadiazole-2-thiol, and 2-amino-1,3,4-thiadiazole (CAS: 4005-51-0). For example, the azole compound comprises 2,5-dimercapto-1,3,4-thiadiazole. Additionally, the nitrogen-containing heterocyclic compound may be in the form of a salt, such as a sodium salt.

The nitrogen-containing heterocyclic compound may be present in the sealing composition at a concentration of at least 0.0005 g per liter of composition, such as at least 0.0008 g per liter of composition, such as at least 0.002 g per liter of composition, and in some instances, may be present in the sealing composition in an amount of no more than 3 g per liter of composition, such as no more than 0.2 g per liter of composition, such as no more than 0.1 g per liter of composition. The nitrogen-containing heterocyclic compound may be present in the sealing composition (if at all) at a concentration of 0.0005 g per liter of composition to 3 g per liter of composition, such as 0.0008 g per liter of composition to 0.2 g per liter of composition, such as 0.002 g per liter of composition to 0.1 g per liter of composition.

The sealing composition may comprise an aqueous medium and optionally may contain other materials such as at least one organic solvent. Nonlimiting examples of suitable such solvents include propylene glycol, ethylene glycol, glycerol, low molecular weight alcohols, and the like. When present, if at all, the organic solvent may be present in the sealing composition in an amount of at least 1 g solvent per liter of sealing composition, such as at least about 2 g solvent per liter of sealing solution, and in some instances, may be present in an amount of no more than 40 g solvent per liter of sealing composition, such as no more than 20 g solvent per liter of sealing solution. The organic solvent may be present in the sealing composition, if at all, in an amount of 1 g solvent per liter of sealing composition to 40 g solvent per liter of sealing composition, such as 2 g solvent per liter of sealing composition to 20 g solvent per liter of sealing composition.

The pH of the sealing composition may be at least 9.5, such as at least 10, such as at least 11, and in some instances may be no higher than 12.5, such as no higher than 12, such as no higher than 11.5. The pH of the sealing composition may be 9.5 to 12.5, such as 10 to 12, such as 11 to 11.5. The pH of the sealing composition may be adjusted using, for example, any acid and/or base as is necessary. The pH of the sealing composition may be maintained through the inclusion of an acidic material, including carbon dioxide, water soluble and/or water dispersible acids, such as nitric acid, sulfuric acid, and/or phosphoric acid. The pH of the sealing composition may be maintained through the inclusion of a basic material, including water soluble and/or water dispersible bases, including carbonates such as Group I carbonates, Group II carbonates, hydroxides such as sodium hydroxide, potassium hydroxide, or ammonium hydroxide, ammonia, and/or amines such as triethylamine, methylethyl amine, or mixtures thereof.

As mentioned above, the sealing composition may comprise a carrier, often an aqueous medium, so that the composition is in the form of a solution or dispersion of the lithium cation in the carrier. The solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion when applied to the metal substrate may be at a temperature ranging from 40° F. to about 160° F., such as 60° F. to 110° F. For example, the process of contacting the metal substrate with the sealing composition may be carried out at ambient or room temperature. The contact time is often from about 1 second to about 15 minutes, such as about 5 seconds to about 2 minutes.

Following the contacting with the sealing composition, the substrate optionally may be air dried at room temperature or may be dried with hot air, for example, by using an air knife, by flashing off the water by brief exposure of the substrate to a high temperature, such as by drying the substrate in an oven at 15° C. to 100° C., such as 20° C. to 90° C., or in a heater assembly using, for example, infrared heat, such as for 10 minutes at 70° C., or by passing the substrate between squeegee rolls. The substrate surface may be partially, or in some instances, completely dried prior to any subsequent contact of the substrate surface with any water, solutions, compositions, or the like. As used herein with respect to a substrate surface, “completely dry” or “completely dried” means there is no moisture on the substrate surface visible to the human eye.

Optionally, following the contacting with the sealing composition, the substrate optionally is not rinsed or contacted with any aqueous solutions prior to contacting at least a portion of the substrate surface with subsequent treatment compositions to form films, layers, and/or coatings thereon (described below).

Optionally, following the contacting with the sealing composition, the substrate optionally may be contacted with tap water, deionized water, RO water and/or any aqueous solution known to those of skill in the art of substrate treatment, wherein such water or aqueous solution may be at a temperature of room temperature (60° F.) to 212° F. The substrate then optionally may be dried, for example air dried or dried with hot air as described in the preceding paragraph such that the substrate surface may be partially, or in some instances, completely dried prior to any subsequent contact of the substrate surface with any water, solutions, compositions, or the like.

A substrate treated with the conditioner composition and the first pretreatment composition of the present invention may have a reduction in the number of pits (counted by the unaided eye) and/or a reduction in the percent of the substrate surface corrosion on a surface of the substrate following exposure to neutral salt spray testing (ASTM B117) for 7 days compared to a substrate not treated with the conditioner composition and the first pretreatment composition of the present invention following exposure to neutral salt spray testing (ASTM B117) for 7 days.

A substrate treated with the conditioner composition and the first pretreatment composition of the present invention may have a reduction in the number of pits (counted using a Keyence VR3200 3D Measuring Macroscope, counting pits with a depth of greater than 3 μm and an area at the surface of larger than 10,000 μm\hat{ }2 (at 3 μm depth)) and/or a reduction in the percent of the substrate surface corrosion on a surface of the substrate following exposure to neutral salt spray testing (ASTM B117) for 1 day compared to a substrate not treated with the conditioner composition and the first pretreatment composition of the present invention following exposure to neutral salt spray testing (ASTM B117) for 1 day.

It was surprisingly discovered that the combination of a conditioner composition comprising a hydroxide anion and a pretreatment composition comprising a magnesium cation provides corrosion protection to a treated substrate, and it was a further surprising discovery that coupling such conditioner composition and pretreatment composition with known substrate protection treatments further enhanced performance compared to substrates treated with such known substrate protection treatments without prior treatment with the conditioner composition and the pretreatment composition of the present invention. It also was surprisingly discovered that a substrate treated with the conditioner composition and the pretreatment composition comprising a magnesium cation leads to a substrate surface having at least 10 atomic % from the air/substrate surface interface to at least 750 nm below the air/substrate surface interface, such as at least 12 atomic %, such as at least 13 atomic % as measured by XPS depth profiling (using a Physical Electronics VersaProbe II instrument equipped with a monochromatic Al kα x-ray source (hν=1,486.7 eV) and a concentric hemispherical analyzer).

According to the present invention, after the substrate is contacted with the conditioner composition and the first pretreatment composition (and optionally the second pretreatment composition and/or the sealing composition), a coating composition comprising a film-forming resin may be deposited onto at least a portion of the treated substrate surface. Any suitable technique may be used to deposit such a coating composition onto the substrate, including, for example, brushing, dipping, flow coating, spraying and the like. In some instances, however, as described in more detail below, such depositing of a coating composition may comprise an electrocoating step wherein an electrodepositable composition is deposited onto a metal substrate by electrodeposition. In certain other instances, as described in more detail below, such depositing of a coating composition comprises a powder coating step. In still other instances, the coating composition may be a liquid coating composition.

According to the present invention, the coating composition may comprise a thermosetting film-forming resin or a thermoplastic film-forming resin. As used herein, the term “film-forming resin” refers to resins that can form a self-supporting continuous film on at least a horizontal surface of a substrate upon removal of any diluents or carriers present in the composition or upon curing at ambient or elevated temperature. Conventional film-forming resins that may be used include, without limitation, those typically used in automotive OEM coating compositions, automotive refinish coating compositions, industrial coating compositions, architectural coating compositions, coil coating compositions, and aerospace coating compositions, among others. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. Curing or crosslinking reactions also may be carried out under ambient conditions. Once cured or crosslinked, a thermosetting resin will not melt upon the application of heat and is insoluble in solvents. As used herein, the term “thermoplastic” refers to resins that comprise polymeric components that are not joined by covalent bonds and thereby can undergo liquid flow upon heating and are soluble in solvents.

As previously indicated, according to the present invention, an electrodepositable coating composition comprising a water-dispersible, ionic salt group-containing film-forming resin that may be deposited onto the substrate by an electrocoating step wherein the electrodepositable coating composition is deposited onto the metal substrate by electrodeposition.

The ionic salt group-containing film-forming polymer may comprise a cationic salt group containing film-forming polymer for use in a cationic electrodepositable coating composition. As used herein, the term “cationic salt group-containing film-forming polymer” refers to polymers that include at least partially neutralized cationic groups, such as sulfonium groups and ammonium groups, that impart a positive charge. The cationic salt group-containing film-forming polymer may comprise active hydrogen functional groups, including, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers. Examples of polymers that are suitable for use as the cationic salt group-containing film-forming polymer include, but are not limited to, alkyd polymers, acrylics, polyepoxides, polyamides, polyurethanes, polyureas, polyethers, and polyesters, among others.

The cationic salt group-containing film-forming polymer may be present in the cationic electrodepositable coating composition in an amount of 40% to 90% by weight, such as 50% to 80% by weight, such as 60% to 75% by weight, based on the total weight of the resin solids of the electrodepositable coating composition. As used herein, the “resin solids” include the ionic salt group-containing film-forming polymer, curing agent, and any additional water-dispersible non-pigmented component(s) present in the electrodepositable coating composition.

Alternatively, the ionic salt group containing film-forming polymer may comprise an anionic salt group containing film-forming polymer for use in an anionic electrodepositable coating composition. As used herein, the term “anionic salt group containing film-forming polymer” refers to an anionic polymer comprising at least partially neutralized anionic functional groups, such as carboxylic acid and phosphoric acid groups that impart a negative charge. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Patent Application Publication No. 2009-0045071 at [0004]-[0015] and U.S. patent application Ser. No. 13/232,093 at [0014]-[0040], the cited portions of which being incorporated herein by reference.

The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition.

The electrodepositable coating composition may further comprise a curing agent. The curing agent may react with the reactive groups, such as active hydrogen groups, of the ionic salt group-containing film-forming polymer to effectuate cure of the coating composition to form a coating. Non-limiting examples of suitable curing agents are at least partially blocked polyisocyanates, aminoplast resins and phenoplast resins, such as phenolformaldehyde condensates including allyl ether derivatives thereof.

The curing agent may be present in the cationic electrodepositable coating composition in an amount of 10% to 60% by weight, such as 20% to 50% by weight, such as 25% to 40% by weight, based on the total weight of the resin solids of the electrodepositable coating composition. Alternatively, the curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

The electrodepositable coating composition may further comprise other optional ingredients, such as a pigment composition and, if desired, various additives such as fillers, plasticizers, anti-oxidants, biocides, UV light absorbers and stabilizers, hindered amine light stabilizers, defoamers, fungicides, dispersing aids, flow control agents, surfactants, wetting agents, or combinations thereof.

The electrodepositable coating composition may comprise water and/or one or more organic solvent(s). Water can for example be present in amounts of 40% to 90% by weight, such as 50% to 75% by weight, based on total weight of the electrodepositable coating composition. If used, the organic solvents may typically be present in an amount of less than 10% by weight, such as less than 5% by weight, based on total weight of the electrodepositable coating composition. The electrodepositable coating composition may in particular be provided in the form of an aqueous dispersion. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The cationic electrodepositable coating composition may be deposited upon an electrically conductive substrate by placing the composition in contact with an electrically conductive cathode and an electrically conductive anode, with the surface to be coated being the cathode. Alternatively, the anionic electrodepositable coating composition may be deposited upon an electrically conductive substrate by placing the composition in contact with an electrically conductive cathode and an electrically conductive anode, with the surface to be coated being the anode. An adherent film of the electrodepositable coating composition is deposited in a substantially continuous manner on the cathode or anode when a sufficient voltage is impressed between the electrodes. The applied voltage may be varied and can be, for example, as low as one volt to as high as several thousand volts, such as between 50 and 500 volts. Current density is usually between 1.0 ampere and 15 amperes per square foot (10.8 to 161.5 amperes per square meter) and tends to decrease quickly during the electrodeposition process, indicating formation of a continuous self-insulating film.

Once the cationic or anionic electrodepositable coating composition is electrodeposited over at least a portion of the electroconductive substrate, the coated substrate is heated to a temperature and for a time sufficient to cure the electrodeposited coating on the substrate. For cationic electrodeposition, the coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). For anionic electrodeposition, the coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.), such as 200° F. to 210.2° F. (93° C. to 99° C.). The curing time may be dependent upon the curing temperature as well as other variables, for example, the film thickness of the electrodeposited coating, level and type of catalyst present in the composition and the like. For example, the curing time can range from 10 minutes to 60 minutes, such as 20 to 40 minutes. The thickness of the resultant cured electrodeposited coating may range from 2 to 50 microns.

Alternatively, as mentioned above, according to the present invention, after the substrate has been contacted with the sealing composition, a powder coating composition may then be deposited onto at least a portion of the surface of the substrate. As used herein, “powder coating composition” refers to a coating composition which is completely free of water and/or solvent. Accordingly, the powder coating composition disclosed herein is not synonymous to waterborne and/or solvent-borne coating compositions known in the art.

According to the present invention, the powder coating composition may comprise (a) a film forming polymer having a reactive functional group; and (b) a curing agent that is reactive with the functional group. Examples of powder coating compositions that may be used in the present invention include the polyester-based ENVIROCRON line of powder coating compositions (commercially available from PPG Industries, Inc.) or epoxy-polyester hybrid powder coating compositions. Alternative examples of powder coating compositions that may be used in the present invention include low temperature cure thermosetting powder coating compositions comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,470,752, assigned to PPG Industries, Inc. and incorporated herein by reference); curable powder coating compositions generally comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,432,333, assigned to PPG Industries, Inc. and incorporated herein by reference); and those comprising a solid particulate mixture of a reactive group-containing polymer having a T_{g} of at least 30° C. (such as those described in U.S. Pat. No. 6,797,387, assigned to PPG Industries, Inc. and incorporated herein by reference).

After deposition of the powder coating composition, the coating is often heated to cure the deposited composition. The heating or curing operation is often carried out at a temperature in the range of from 150° C. to 200° C., such as from 170° C. to 190° C., for a period of time ranging from 10 to 20 minutes. According to the invention, the thickness of the resultant film is from 50 microns to 125 microns.

As mentioned above, according to the present invention, the coating composition may be a liquid coating composition. As used herein, “liquid coating composition” refers to a coating composition which contains a portion of water and/or solvent. Accordingly, the liquid coating composition disclosed herein is synonymous to waterborne and/or solvent-borne coating compositions known in the art.

According to the present invention, the liquid coating composition may comprise, for example, (a) a film forming polymer having a reactive functional group; and (b) a curing agent that is reactive with the functional group. In other examples, the liquid coating may contain a film forming polymer that may react with oxygen in the air or coalesce into a film with the evaporation of water and/or solvents. These film-forming mechanisms may require or be accelerated by the application of heat or some type of radiation such as Ultraviolet or Infrared. Examples of liquid coating compositions that may be used in the present invention include the SPECTRACRON® line of solvent-based coating compositions, the AQUACRON® line of water-based coating compositions, and the RAYCRON® line of UV cured coatings (all commercially available from PPG Industries, Inc.).

Suitable film forming polymers that may be used in the liquid coating composition of the present invention may comprise a (poly)ester, an alkyd, a (poly)urethane, an isocyanurate, a (poly)urea, a (poly)epoxy, an anhydride, an acrylic, a (poly)ether, a (poly)sulfide, a (poly)amine, a (poly)amide, (poly)vinyl chloride, (poly)olefin, (poly)vinylidene fluoride, (poly)siloxane, or combinations thereof.

According to the present invention, the substrate that has been contacted with the sealing composition may also be contacted with a primer composition and/or a topcoat composition. The primer coat may be, for examples, chromate-based primers and advanced performance topcoats. According to the present invention, the primer coat can be a conventional chromate-based primer coat, such as those available from PPG Industries, Inc. (product code 44GN072), or a chrome-free primer such as those available from PPG (DESOPRIME CA7502, DESOPRIIME CA7521, Deft 02GN083, Deft 02GN084). Alternately, the primer coat can be a chromate-free primer coat, such as the coating compositions described in U.S. patent application Ser. No. 10/758,973, entitled “Corrosion Resistant Coatings Containing Carbon”, and U.S. patent application Ser. Nos. 10/758,972, and 10/758,972, both entitled “Corrosion Resistant Coatings”, all of which are incorporated herein by reference, and other chrome-free primers that are known in the art, and which can pass the military requirement of MIL-PRF-85582 Class N or MIL-PRF-23377 Class N may also be used with the current invention.

As mentioned above, the substrate of the present invention also may comprise a topcoat. As used herein, the term “topcoat” refers to a mixture of binder(s) which can be an organic or inorganic based polymer or a blend of polymers, typically at least one pigment, can optionally contain at least one solvent or mixture of solvents, and can optionally contain at least one curing agent. A topcoat is typically the coating layer in a single or multi-layer coating system whose outer surface is exposed to the atmosphere or environment, and its inner surface is in contact with another coating layer or polymeric substrate. Examples of suitable topcoats include those conforming to MIL-PRF-85285D, such as those available from PPG (Deft 03W127A and Deft 03GY292). According to the present invention, the topcoat may be an advanced performance topcoat, such as those available from PPG (Defthane® ELT™ 99GY001 and 99W009). However, other topcoats and advanced performance topcoats can be used in the present invention as will be understood by those of skill in the art with reference to this disclosure.

According to the present invention, the metal substrate also may comprise a self-priming topcoat, or an enhanced self-priming topcoat. The term “self-priming topcoat”, also referred to as a “direct to substrate” or “direct to metal” coating, refers to a mixture of a binder(s), which can be an organic or inorganic based polymer or blend of polymers, typically at least one pigment, can optionally contain at least one solvent or mixture of solvents, and can optionally contain at least one curing agent. The term “enhanced self-priming topcoat”, also referred to as an “enhanced direct to substrate coating” refers to a mixture of functionalized fluorinated binders, such as a fluoroethylene-alkyl vinyl ether in whole or in part with other binder(s), which can be an organic or inorganic based polymer or blend of polymers, typically at least one pigment, can optionally contain at least one solvent or mixture of solvents, and can optionally contain at least one curing agent. Examples of self-priming topcoats include those that conform to TT-P-2756A. Examples of self-priming topcoats include those available from PPG (03W169 and 03GY369), and examples of enhanced self-priming topcoats include Defthane® EL™/ESPT and product code number 97GY121, available from PPG. However, other self-priming topcoats and enhanced self-priming topcoats can be used in the coating system according to the present invention as will be understood by those of skill in the art with reference to this disclosure.

According to the present invention, the self-priming topcoat and enhanced self-priming topcoat may be applied directly to the sealed substrate. The self-priming topcoat and enhanced self-priming topcoat can optionally be applied to an organic or inorganic polymeric coating, such as a primer or paint film. The self-priming topcoat layer and enhanced self-priming topcoat is typically the coating layer in a single or multi-layer coating system where the outer surface of the coating is exposed to the atmosphere or environment, and the inner surface of the coating is typically in contact with the substrate or optional polymer coating or primer.

According to the present invention, the topcoat, self-priming topcoat, and enhanced self-priming topcoat can be applied to the sealed substrate, in either a wet or “not fully cured” condition that dries or cures over time, that is, solvent evaporates and/or there is a chemical reaction. The coatings can dry or cure either naturally or by accelerated means for example, an ultraviolet light cured system to form a film or “cured” paint. The coatings can also be applied in a semi or fully cured state, such as an adhesive.

In addition, a colorant and, if desired, various additives such as surfactants, wetting agents or catalyst can be included in the coating composition (electrodepositable, powder, or liquid). As used herein, the term “colorant” means any substance that imparts color and/or other opacity and/or other visual effect to the composition. Example colorants include pigments, dyes and tints, such as those used in the paint industry and/or listed in the Dry Color Manufacturers Association (DCMA), as well as special effect compositions.

In general, the colorant can be present in the coating composition in any amount sufficient to impart the desired visual and/or color effect. The colorant may comprise from 1 to 65 weight percent, such as from 3 to 40 weight percent or 5 to 35 weight percent, with weight percent based on the total weight of the composition.

In view of the foregoing description the present invention thus relates in particular, without being limited thereto, to the following Aspects 1 to 22:

Aspect 1. A system for treating a metal substrate, comprising: a conditioner composition comprising a hydroxide anion; and a first pretreatment composition comprising a magnesium element, a halide element, and an oxidizing agent.

Aspect 2. The system of Aspect 1, wherein the conditioner composition has a pH of 9.0 to 13.5.

Aspect 3. The system of Aspect 1 or Aspect 2, wherein the magnesium element and the halide element are derived from a single source.

Aspect 4. The system of any of the preceding Aspects, wherein the magnesium element is derived from a first source and the halide element is derived from a second source.

Aspect 5. The system of any of the preceding Aspects, wherein the magnesium element is present in the first pretreatment composition in an amount of 500 ppm to 6000 ppm based on total weight of the first pretreatment composition.

Aspect 6. The system of any of the preceding Aspects, wherein the halide element is present in the first pretreatment composition in an amount of 3000 ppm to 40,000 ppm based on total weight of the first pretreatment composition.

Aspect 7. The system of any of the preceding Aspects, wherein the oxidizing agent is present in the first pretreatment composition in an amount of 100 ppm to 3000 ppm based on total weight of the first pretreatment composition.

Aspect 8. The system of any of the preceding Aspects, wherein the first pretreatment composition has a pH of 1.0 to 7.0.

Aspect 9. The system of any of Aspects 1 to 8, wherein the first pretreatment composition has a pH of 4.0 to 9.0.

Aspect 10. The system of any of Aspects 1 to 8, wherein the first pretreatment composition has a pH of 7.0 to 11.0.

Aspect 11. The system of any of the preceding Aspects, further comprising a cleaning composition.

Aspect 12. The system of any of the preceding Aspects, further comprising a deoxidizer.

Aspect 13. The system of any of the preceding Aspects, further comprising a second pretreatment composition comprising a rare earth element.

Aspect 14. The system of Aspect 13, wherein the rare earth element is present in the second pretreatment composition in an amount of 50 ppm to 500 ppm based on total weight of the second pretreatment composition.

Aspect 15. The system of any of the preceding Aspects, further comprising a sealing composition comprising a lithium element.

Aspect 16. The system of Aspect 15, wherein the lithium element is present in the sealing composition in an amount of 5 ppm to 5500 ppm based on total weight of the sealing composition.

Aspect 17. A substrate obtainable by the system of any of the preceding Aspects.

Aspect 18. The substrate of Aspect 17, wherein the substrate has at least one of the following:

(a) a reduction in the number of pits (counted by the unaided eye) on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;

(b) a reduction in the percent of surface corrosion on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;

(c) a reduction in the number of pits (counted using a Keyence VR3200 3D Measuring Macroscope, counting pits with a depth of greater than 3 μm and an area at the surface of larger than 10,000 μm\hat{ }2 (at 3 μm depth)) on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day;

(d) a reduction in the percent of the substrate surface corrosion on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day; or

(e) at least 10 atomic % from the air/substrate surface interface to at least 750 nm below the air/substrate surface interface as measured by XPS depth profiling (using a Physical Electronics VersaProbe II instrument equipped with a monochromatic Al kα x-ray source (hν=1,486.7 eV) and a concentric hemispherical analyzer).

Aspect 19. A method of treating a substrate, comprising:

contacting at least a portion of the substrate with a conditioner composition having a pH greater than 9.0; and

contacting at least a portion of the substrate contacted with the conditioner composition with a first pretreatment composition comprising a magnesium element, a halide element, and an oxidizing agent.

Aspect 20. The method of Aspect 19, further comprising contacting at least a portion of the substrate contacted with the first pretreatment composition with a second pretreatment composition comprising a rare earth element.

Aspect 21. The method of Aspect 19 or Aspect 20, further comprising contacting at least a portion of the substrate contacted with the second pretreatment composition with a sealing composition comprising a lithium element.

Aspect 22. A substrate obtainable by the method of any of Aspects 19 to 21.

Aspect 23. The substrate of Aspect 22, wherein the substrate has:

(a) a reduction in the number of pits (counted by the unaided eye) on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;

(b) a reduction in the percent of surface corrosion on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;

(c) a reduction in the number of pits (counted using a Keyence VR3200 3D Measuring Macroscope, counting pits with a depth of greater than 3 μm and an area at the surface of larger than 10,000 μm\hat{ }2 (at 3 μm depth)) on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day;

(d) a reduction in the percent of the substrate surface corrosion on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day; or

(e) at least 10 atomic % from the air/substrate surface interface to at least 750 nm below the air/substrate surface interface as measured by XPS depth profiling (using a Physical Electronics VersaProbe II instrument equipped with a monochromatic Al kα x-ray source (hν=1,486.7 eV) and a concentric hemispherical analyzer).

Illustrating the invention are the following examples that are not to be considered as limiting the invention to their details. All parts and percentages in the examples, as well as throughout the specification, are by weight unless otherwise indicated.

### EXAMPLES

TABLE 2
Materials

| | |
|---|---|
| Ridoline 298 | Henkel |
| Deoxidizer 6 | Henkel |
| Nitric acid, 68-70% | Fisher |
| Sodium hydroxide, 98% | Alfa Aesar |
| Magnesium chloride hexahydrate, 98% | Alfa Aesar |
| Potassium hydroxide solution, 45% | Fisher |
| Magnesium sulfate heptahydrate, 100% | Fisher |
| Potassium chloride, 99.7% | Fisher |
| Hydrogen peroxide, 35% | Alfa Aesar |
| Cerium nitrate solution (65.37% Ce(NO₃)³•6H₂O) | ProChem Inc. |
| Yttrium nitrate solution (72.78% Y(NO₃)₃•6H₂O) | ProChem Inc. |
| Cerium chloride solution (32.2% as CeO₂*) | ProChem Inc. |
| Lithium carbonate, 99% | Alfa Aesar |

*As per the supplier's analytical report, the concentration of cerium in the cerium chloride solution is measured as cerium oxide (CeO₂).

TABLE 3
Cleaner Composition - Example A

| Material | Parts by Volume |
|---|---|
| Ridoline 298 (R298) | 100 |
| Tap water | 900 |

The materials used to prepare Cleaner Composition (Example A) are shown in Table 3. Example A was prepared per manufacturer's instructions.

TABLE 4
Deoxidizer Composition - Example B

| Material | Parts by Volume |
|---|---|
| Deoxidizer 6 | 100 |
| Nitric acid, 68-70% | 200 |
| Tap water | 700 |

The materials used to prepare Deoxidizer Composition (Example B) are shown in Table 4. Example B was prepared per manufacturers' instructions.

TABLE 5
Conditioning Composition - Example C

| Material | Mass (g) |
|---|---|
| Sodium hydroxide, 98% | 2.51 |
| Deionized water | 1899 |

The materials used to prepare Deoxidizer Composition (Example C) are shown in Table 5. Example C was prepared by dissolving sodium hydroxide in deionized water under mild agitation.

TABLE 6
1% Potassium Hydroxide Composition - Example D

| Material | Mass (g) |
|---|---|
| Potassium hydroxide, 45% | 10.0 |
| Deionized water | 440 |

The materials used to prepare the potassium hydroxide composition Example D are shown in Table 6. Example D was prepared by diluting the potassium hydroxide solution with deionized water while manually stirring.

TABLE 7
Magnesium Pretreatment Coating Compositions - Examples E to H

| | Magne- | Magne- | Potas- | | Deion- |
|---|---|---|---|---|---|
| | sium | sium | sium | Hydrogen | ized |
| | Chloride | Sulfate | Chloride | Peroxide | Water |
| | (g) | (g) | (g) | (g) | (g) |
| Example E | 24.40 | 0.00 | 0.00 | 5.00 | 1871 |
| Example F | 0.00 | 29.58 | 0.00 | 5.00 | 1865 |
| Example G | 24.40 | 0.00 | 0.00 | 0.00 | 1876 |
| Example H | 0.00 | 29.58 | 3.50 | 5.00 | 1862 |

The materials used to prepare the magnesium-containing pretreatment compositions (Examples E-H) are shown in Table 7. Each of Examples E-H was prepared by first dissolving the magnesium salt in the deionized water. The magnesium composition was brought to the final pH using the potassium hydroxide composition of Example D. Then, the hydrogen peroxide was added to the composition and stirred for a minimum of 30 minutes prior to use. Examples E1, E2, and E3 were prepared as described for Example E, but the composition was brought to the final pH by adding hydrogen chloride dropwise until the desired pH was reached as reported in Table 11.

TABLE 8
Rare Earth Pretreatment Compositions - Examples I and J

| | Yttrium | Cerium | Cerium | Hydrogen | |
|---|---|---|---|---|---|
| | Nitrate | Nitrate | Chloride | Peroxide | Deionized |
| | Solution | Solution | Solution | Solution | Water |
| | (g) | (g) | (g) | (g) | (g) |
| Example I | 12.00 | 10.00 | 0.04 | 1.00 | 1878 |
| Example J | 0.00 | 0.00 | 12.00 | 1.00 | 1884 |

The materials used to prepare the rare-earth containing compositions of Examples I and J are shown in Table 8. Example H was prepared by weighing cerium nitrate, yttrium nitrate and cerium chloride solutions into individual cups. Then using about 500 grams of deionized water, the rare earth solutions were transferred to a vessel containing 1000 grams of deionized water under mild agitation. The balance of the water was added and the solution stirred for 10 minutes to ensure uniformity before the hydrogen peroxide was added. The final composition was stirred for a minimum of 30 minutes before use.

Example I was prepared by adding the cerium chloride solution to the full amount of deionized water under mild agitation. The solution was stirred for 10 minutes to ensure uniformity before the hydrogen peroxide was added. The final composition was stirred for a minimum of 30 minutes before use.

TABLE 9
Seal Composition - Example K

| Material | Mass (g) |
|---|---|
| lithium carbonate 99%, grams | 5.84 |
| deionized water, grams | 3794 |

The materials used to prepare the seal composition (Example K) are shown in Table 9. Example K was prepared by dissolving lithium carbonate in deionized water under mild agitation.

The pH of each bath prepared is reported in Table 11.

In the following Examples, panels were placed in a neutral salt spray cabinet operated according to ASTM B117 for 7-day corrosion testing. As used herein, any reference to a salt spray cabinet operated according to ASTM B117 refers to a salt spray cabinet operated according to ASTM B117 modified for weekly (rather than daily) verification of salt fog pH, tower temperature and amount of fog generated per hour.

### Example 1 (Comparative)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in a deoxidizing composition of Example B for 1.5 minutes at ambient temperature followed by a 1-minute immersion rinse in tap water at ambient temperature and mild agitation followed by a 5-second cascading deionized water rinse. The panel was then immersed in the pretreatment composition of Example I for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits (as defined above) visible to the unaided eye on the panels. Data are reported in Table 10.

### Example 2 (Comparative)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in a deoxidizing composition of Example B for 1.5 minutes at ambient temperature followed by a 1-minute immersion rinse in tap water at ambient temperature and mild agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits (as defined above) visible to the unaided eye on the panels. Data are reported in Table 10.

### Example 3 (Comparative)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in a deoxidizing composition of Example B for 1.5 minutes at ambient temperature followed by a 1-minute immersion rinse in tap water at ambient temperature and mild agitation followed by a 5-second cascading deionized water rinse. Subsequently, the panel was immersed in a conditioning composition of Example C for 2 minutes followed by a deionized water immersion rinse for 1 minute with intermittent agitation then a 5-second cascading deionized water rinse. The panel was then immersed in the pretreatment composition of Example I for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits (defined above) visible to the unaided eye on the panels. Data are reported in Table 10.

### Example 4 (Comparative)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in a deoxidizing composition of Example B for 1.5 minutes at ambient temperature followed by a 1-minute immersion rinse in tap water at ambient temperature and mild agitation followed by a 5-second cascading deionized water rinse. The panel was then immersed in the pretreatment composition of Example E for 5 minutes followed by a 2-minute deionized water immersion rinse and a 5-second cascading deionized water rinse. The panel was then immersed in the pretreatment composition of Example I for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits (defined above) visible to the unaided eye on the panels. Data are reported in Table 10.

### Example 5 (Comparative)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in a deoxidizing composition of Example B for 1.5 minutes at ambient temperature followed by a 1-minute immersion rinse in tap water at ambient temperature and mild agitation followed by a 5-second cascading deionized water rinse. Subsequently, the panel was immersed in the conditioning composition of Example C for 2 minutes followed by a deionized water immersion rinse for 1 minute with intermittent agitation then a 5-second cascading deionized water rinse. The panel was then immersed in the pretreatment composition of Example F for 5 minutes at ambient temperature without agitation. After the pretreatment composition, the panel received an immersion rinse in deionized water for 2 minutes at ambient temperature with intermittent agitation followed by a 5-second cascading deionized water rinse. The panel was then immersed in the pretreatment composition of Example I for 5 minutes at ambient temperature without agitation. After the pretreatment composition, the panel received an immersion rinse in deionized water for 2 minutes at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits (defined above) visible to the unaided eye on the panels. Data are reported in Table 10.

### Example 6 (Comparative)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in a deoxidizing composition of Example B for 1.5 minutes at ambient temperature followed by a 1-minute immersion rinse in tap water at ambient temperature and mild agitation followed by a 5-second cascading deionized water rinse. Subsequently, the panel was immersed in a conditioning composition of Example C for 2 minutes followed by a deionized water immersion rinse for 1 minute with intermittent agitation then a 5-second cascading deionized water rinse. The panel was then immersed in the pretreatment composition of Example G for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the pretreatment composition of Example I for 5 minutes at ambient temperature without agitation. After the pretreatment coating, the panel was rinsed in an immersion rinse in deionized water for 2-minute at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits (defined above) visible to the unaided eye on the panels. Data are reported in Table 10.

### Example 7 (Experimental)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in the deoxidizing composition of Example B for 1.5 minutes at ambient temperature followed by a 1-minute immersion rinse in tap water at ambient temperature and mild agitation followed by a 5-second cascading deionized water rinse. Subsequently, the panel was immersed in the conditioning composition of Example C for 2 minutes followed by a deionized water immersion rinse for 1 minute with intermittent agitation then a 5-second cascading deionized water rinse. The panel was then immersed in the pretreatment composition of Example E for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the pretreatment composition of Example I for 5 minutes at ambient temperature without agitation. After the pretreatment composition, the panel was rinsed in an immersion rinse in deionized water for 2-minute at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

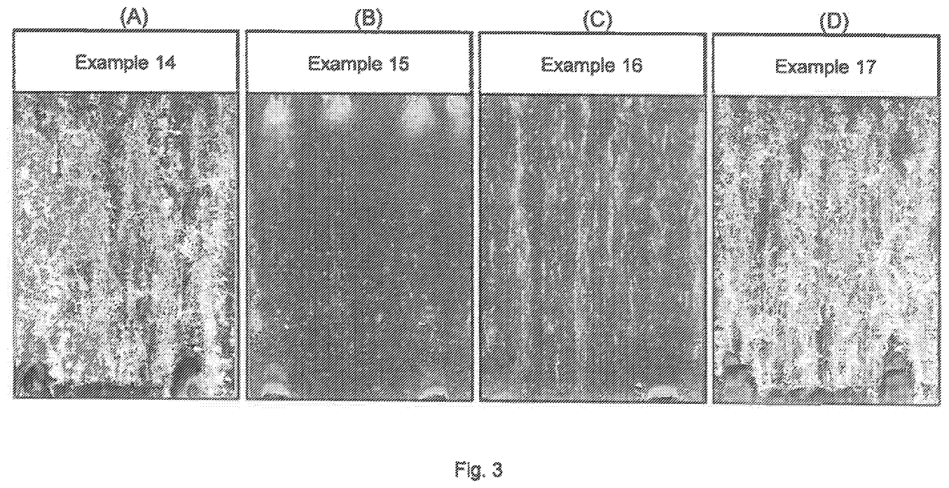

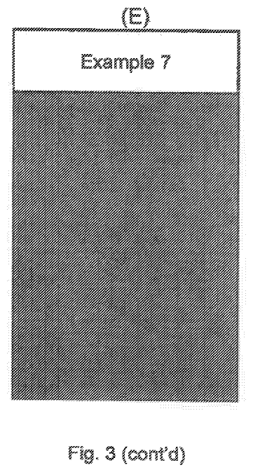

The panel was placed in a neutral salt spray cabinet operated according to ASTM B117 for 7-day corrosion testing. Corrosion performance was evaluated by counting the number of pits visible to the unaided eye on the panels. Data are reported in Table 10. An image of the panel is shown in FIG. 3(E).

### Example 8 (Experimental)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in the deoxidizing composition of Example B for 1.5 minutes at ambient temperature followed by a 1-minute immersion rinse in tap water at ambient temperature and mild agitation followed by a 5-second cascading deionized water rinse. Subsequently, the panel was immersed in the conditioning composition of Example C for 2 minutes followed by a deionized water immersion rinse for 1 minute with intermittent agitation then a 5-second cascading deionized water rinse. The panel was then immersed in the pretreatment composition of Example H for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the pretreatment composition of Example I for 5 minutes at ambient temperature without agitation. After the pretreatment composition, the panel was rinsed in an immersion rinse in deionized water for 2-minute at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits visible to the unaided eye on the panels. Data are reported in Table 10.

### Example 9 (Experimental)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in the deoxidizing composition of Example B for 1.5 minutes at ambient temperature followed by a 1-minute immersion rinse in tap water at ambient temperature and mild agitation followed by a 5-second cascading deionized water rinse. Subsequently, the panel was immersed in the conditioning solution of Example C for 2 minutes followed by a deionized water immersion rinse for 1 minute with intermittent agitation then a 5-second cascading deionized water rinse. The panel was then immersed in the pretreatment composition of Example E for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits visible to the unaided eye on the panels. Data are reported in Table 10.

### Example 10 (Experimental)

Aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panel was immersed in the cleaner composition of Example A for 2 minutes at 55° C. with mild agitation. The panel was then immersed in a tap water rinse for 1 minute at ambient temperature with mild agitation followed by a 5-second cascading deionized water rinse. The panel was immersed in the deoxidizing composition of Example B for 1.5 minutes at ambient temperature followed by a 1-minute immersion rinse in tap water at ambient temperature and mild agitation followed by a 5-second cascading deionized water rinse. Subsequently, the panel was immersed in the conditioning composition of Example C for 2 minutes followed by a deionized water immersion rinse for 1 minute with intermittent agitation then a 5-second cascading deionized water rinse. The panel was then immersed in the pretreatment composition of Example E for 5 minutes at ambient temperature without agitation. After the pretreatment composition, the panel received an immersion rinse in deionized water for 2 minutes at ambient temperature with intermittent agitation followed by a 5-second cascading deionized water rinse. The panel was then immersed in the pretreatment composition of Example J for 5 minutes at ambient temperature without agitation. After the pretreatment composition, the panel was rinsed in an immersion rinse in deionized water for 2 minutes at ambient temperature with intermittent agitation followed by a 5-second cascading deionized water rinse. The panel was then immersed in the seal composition of Example K for 2 minutes at ambient temperature with intermittent agitation. The panel was air dried at ambient conditions overnight before testing.

The panel was placed in a neutral salt spray cabinet operated according to ASTM B117 for 7-day corrosion testing. Corrosion performance was evaluated by counting the number of pits visible to the unaided eye on the panels. Data are reported in Table 10.

Data from Experiments 1-10 are reported in Table 10 as the total number of pits across the face of the panel. Pits were counted with the unaided eye.

### Examples 11-13 (Experimental)

Six aluminum 2024T3 bare substrate (Priority Metals, Orange County, Calif.) measuring 3″×5″×0.032″ was hand-wiped with methyl ethyl ketone (100%) and a disposable cloth and allowed to air dry prior to chemical cleaning. The panels were immersed in the cleaner composition of Example A for 2 minutes at 55° C. with mild agitation. The panels were then immersed in a tap water rinse for 1 minute at ambient temperature with mild agitation followed by a 5-second cascading deionized water rinse. The panels were immersed in the deoxidizing composition of Example B for 1.5 minutes at ambient temperature followed by a 1-minute immersion rinse in tap water at ambient temperature and mild agitation followed by a 5-second cascading deionized water rinse. Subsequently, the panels were immersed in the conditioning composition of Example C for 2 minutes followed by a deionized water immersion rinse for 1 minute with intermittent agitation then a 5-second cascading deionized water rinse. Two panels were then immersed in the pretreatment composition of Example E-1, two panels were immersed in the pretreatment composition of Example E-2, and two panels were immersed in the pretreatment composition of Example E-3, each for 5 minutes at ambient temperature without agitation. After the pretreatment composition, the panels were rinsed in an immersion rinse in deionized water for 2 minutes at ambient temperature with intermittent agitation followed by a 5-second cascading deionized water rinse. The panels were then immersed in the pretreatment composition of Example I for 5 minutes at ambient temperature without agitation. After the pretreatment composition, the panels were rinsed in an immersion rinse in deionized water for 2-minute at ambient temperature with intermittent agitation followed by a 5-second cascading deionized water rinse. The panels were then immersed in the seal composition of Example K for 2 minutes at ambient temperature with intermittent agitation. The panels were air dried at ambient conditions overnight before testing.

The panels were placed in neutral salt spray cabinet operated according to ASTM B117 for 7-day corrosion testing. Corrosion performance was evaluated by counting the number of pits visible to the unaided eye on the panels. Data are reported in Table 10 as the average number of pits on the two panels per treatment with pretreatment composition Example E-1, E-2, or E-3.

TABLE 10
Number of pits per panel in Experiments 1-10

| | | | | | | Rare Earth | | | |
|---|---|---|---|---|---|---|---|---|---|
| | Hydroxide | Magnesium Pretreatment | | | | Pretreatment | | Seal | # of |
| | Composition | MgCl₂ | MgSO₄ | H₂O₂ | KCl | w/Ce | w/Y | Composition | Pits |
| Example 1 | No | No | No | No | No | Yes | Yes | Yes | 79 |
| Example 2 | No | No | No | No | No | No | No | Yes | 74 |
| Example 3 | Yes | No | No | Yes | No | Yes | Yes | Yes | 69 |
| Example 4 | No | Yes | No | Yes | No | Yes | Yes | Yes | >100 |
| Example 5 | Yes | No | Yes | Yes | No | Yes | Yes | Yes | >100 |
| Example 6 | Yes | Yes | No | No | No | Yes | Yes | Yes | >100 |
| Example 7 | Yes | Yes | No | Yes | No | Yes | Yes | Yes | 0 |
| Example 8 | Yes | No | Yes | Yes | Yes | Yes | Yes | Yes | 0 |
| Example 9 | Yes | Yes | No | Yes | No | No | No | Yes | 29 |
| Example 10 | Yes | Yes | No | Yes | No | Yes | No | Yes | 33 |
| Example 11 | Yes | Yes | No | Yes | No | Yes | Yes | Yes | *0.5 |
| Example 12 | Yes | Yes | No | Yes | No | Yes | Yes | Yes | *0 |
| Example 13 | Yes | Yes | No | Yes | No | Yes | Yes | Yes | *9.5 |

*# of pits is an average of 2 panels

Panels were analyzed using the unaided eye. Pits were counted up to 100. If there were more than 100 pits on a panel, then the number of pits was recorded as >100 pits.

A comparison of the number of pits counted on the panels treated according to Examples 7 and 8 following 7 days of exposure to neutral salt spray results compared to those counted on the panel treated according to comparative Example 1 clearly shows the benefits of the hydroxide conditioner, the magnesium cation, the halide anion, and oxidizing agent when included in a system with a pretreatment comprising rare earth and a seal comprising lithium. Evidence of the improvement is seen by the elimination of pits on the surface of the treated panels (Examples 7 and 8 had zero pits) after exposure to salt spray, while Comparative Example 1 had 79 corrosion pits. It is clear that the same corrosion benefit is achieved regardless of whether the Mg cation source and the halide anion source are derived from a single source or are derived from two different sources.

A comparison of the number of pits counted on the panel treated according to Example 9 following 7 days of exposure to neutral salt spray compared to those counted on the panel treated according to comparative Example 2 demonstrates the benefits of the hydroxide conditioner, the magnesium cation, the halide anion, and oxidizing agent when included in a system with a seal comprising lithium. Evidence of the improvement is seen by the measurable reduction in the number of corrosion pits on the panel treated according to Example 9 (29 pits) versus the panel treated according to comparative Example 2 (74 pits).

A comparison of the number of pits counted on the panel treated according to Example 7 compared to those treated according to Examples 3-6 demonstrates the effect of the condition composition (comprising the hydroxide source) and the first pretreatment composition (containing the magnesium element, the halide, and the hydrogen peroxide) on the number of pits on the panels following 7-day exposure to neutral salt spray in a cabinet operated according to ASTM B117. In contrast, the panel treated according to Example 4, which did not include treating the panel with the conditioner composition, had significant pits on the substrate surface (>100 pits) following 7-day exposure to neutral salt spray in the cabinet. Additionally, the panel treated according to Example 3, which did not include the magnesium element or the halide element in the first pretreatment composition (i.e., only included hydrogen peroxide), had 69 pits on the substrate surface following 7-day exposure to neutral salt spray in the cabinet. The panels treated according to Example 5, which did not include the halide element in the first pretreatment composition, and Example 6, which did not include the oxidizing agent in the first pretreatment composition, each had >100 pits on the substrate surface following 7-day exposure to neutral salt spray in the cabinet.

Example 10 demonstrates that yttrium is not required in the second pretreatment composition to reduce the number of pits on the substrate surface. Cf. panels treated according to Examples 1, 7, and 10.

TABLE 11
pH Values of Baths Used in Examples 1-10

| | Hydroxide | Magnesium Bath | | Rare Earth | Seal |
|---|---|---|---|---|---|
| | Bath | MgCl₂ | MgSO₄ | Bath | Bath |
| Example 1 | n/a | n/a | n/a | 3.70 | 11.21 |
| Example 2 | n/a | n/a | n/a | n/a | 11.30 |
| Example 3 | 12.36 | n/a | n/a | 3.70 | 11.30 |
| Example 4 | n/a | 9.07 | n/a | 3.82 | 11.30 |
| Example 5 | 13.15 | n/a | 9.02 | 4.12 | 11.71 |
| Example 6 | 12.59 | 9.06 | n/a | 4.29 | 11.36 |
| Example 7 | 12.36 | 9.03 | n/a | 3.82 | 11.30 |
| Example 8 | 13.15 | n/a | 9.09 | 4.12 | 11.71 |
| Example 9 | 12.59 | 9.00 | n/a | n/a | 11.36 |
| Example 10 | 12.64 | 9.02 | n/a | 3.87 | 11.18 |
| Example 11 | 12.63 | 5.11 | n/a | 3.73 | 11.22 |
| Example 12 | 12.63 | 4.03 | n/a | 3.73 | 11.22 |
| Example 13 | 12.63 | 2.97 | n/a | 3.73 | 11.22 |

### Example 14 (Comparative)

Two aluminum 2024T3 bare substrate (Bralco Metals, La Mirada, Calif.) and four aluminum 2024T3 bare substrate (Priority Metals, Orange County, Calif.) measuring 3″×5″×0.032″ were hand-wiped with methyl ethyl ketone (100%) and a disposable cloth and allowed to air dry*. Both of the panels from Bralco Metals and two of the panels from Priority Metals were immersed in the cleaner composition of Example A for 2 minutes at 55° C. with mild agitation. The panels were then immersed in a tap water rinse for 1 minute at ambient temperature with mild agitation followed by a 5-second cascading deionized water rinse. The panels were immersed in the deoxidizing composition of Example B for 1.5 minutes at ambient temperature followed by a 1-minute immersion rinse in tap water at ambient temperature and mild agitation followed by a 5-second cascading deionized water rinse. The panels were air dried at ambient conditions overnight before testing.

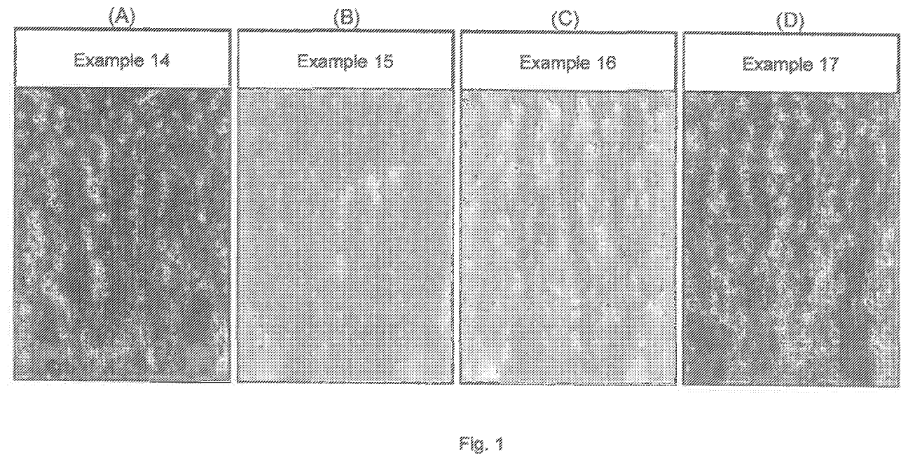

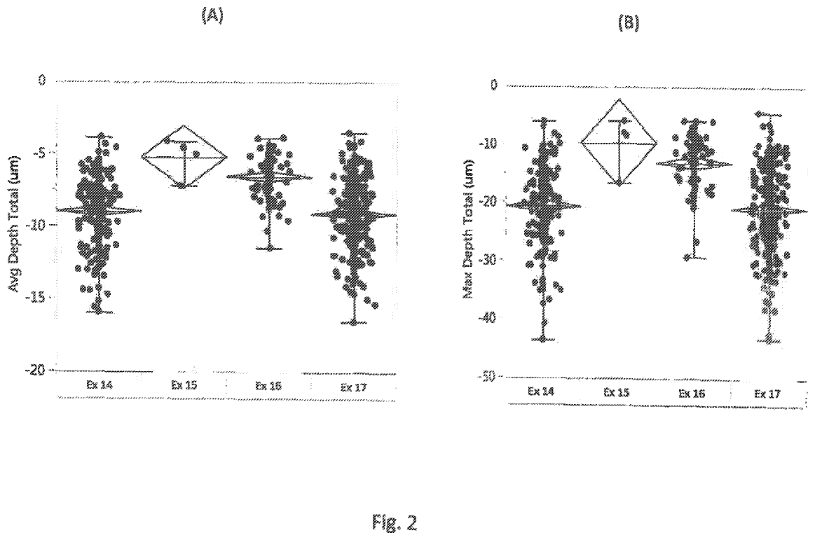

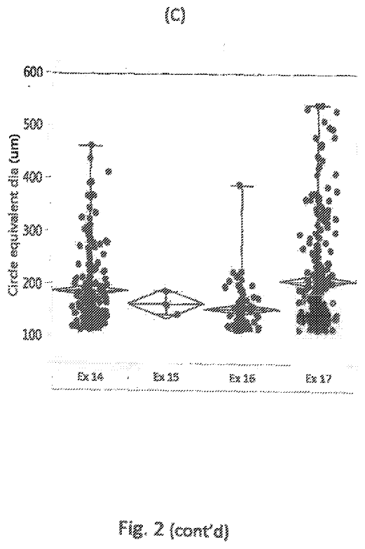

One panel (Bralco) was placed in a neutral salt spray cabinet operated according to ASTM B117 for 1-day corrosion testing and one panel (Bralco) was placed in a neutral salt spray cabinet operated according to ASTM B117 for 7-day corrosion testing. An image of the panel following the 1-day corrosion testing is shown in FIG. 1(A) and an image of the panel following the 7-day corrosion testing is shown in FIG. 3(A). Corrosion performance was evaluated by either evaluating the percentage of the panel that was corroded or by counting the number of pits visible to the unaided eye on the panels. Data are reported in Tables 12 and 13. Corrosion performance also was analyzed using the macroscope described below. Data are reported in FIG. 2.

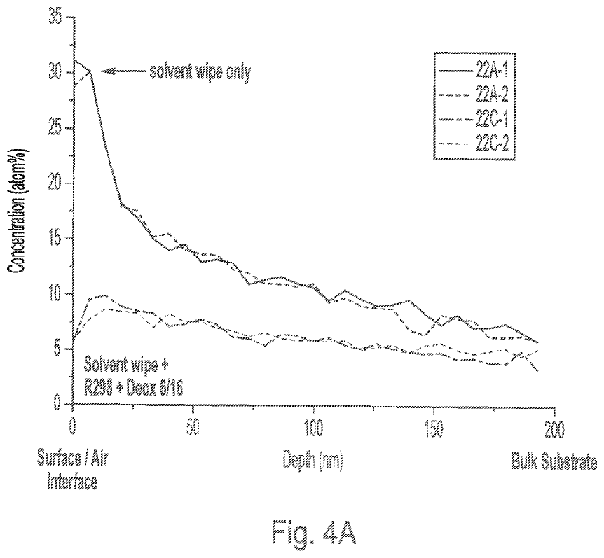

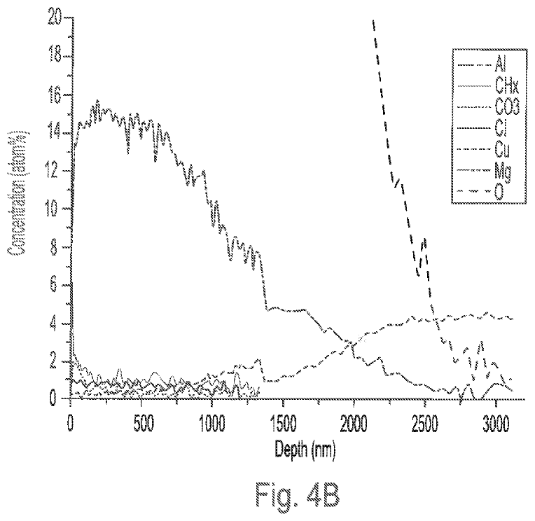

The four remaining panels (Priority Metals) were analyzed to determine the concentration of the elements shown at various depths using XPS depth profiling. Data are shown in FIG. 4A. The XPS depth profile of the substrates were generated using a Physical Electronics VersaProbe II instrument equipped with a monochromatic Al kα x-ray source (hν=1,486.7 eV) and a concentric hemispherical analyzer. Charge neutralization was performed using both low energy electrons (<5 eV) and argon ions. The binding energy axis was calibrated using sputter cleaned Cu foil (Cu 2p3/2=932.62 eV, Cu 2p3/2=75.1 eV) and Au foils (Au 4f7/2=83.96 eV). Peaks were charge referenced to CHx band in the carbon 1s spectra at 284.8 eV. Measurements were made at a takeoff angle of 45° with respect to the sample surface plane. This resulted in a typical sampling depth of 3-6 nm (95% of the signal originated from this depth or shallower). Quantification was done using instrumental relative sensitivity factors (RSFs) that account for the x-ray cross section and inelastic mean free path of the electrons. Ion sputtering was done using 2 kV Ar+ rastered over a 2 mm×2 mm area. The sputtering rate in the Al₂O₃ layer was 9.5 nm/min. These data shown in FIG. 4A demonstrate that the panels treated according to Example 14 had a significant reduction in the amount of magnesium present at the air/substrate interface (about 10 atomic %) compared to panels cleaned with solvent only* (about 30 atomic %).

### Example 15 (Experimental)

Two aluminum 2024T3 bare substrate (Bralco Metals, La Mirada, Calif.) and one aluminum 2024T3 bare substrate (Priority Metals, Orange County, Calif.) measuring 3″×5″×0.032″ were hand-wiped with methyl ethyl ketone (100%) and a disposable cloth and allowed to air dry prior to chemical cleaning. The panels were immersed in the cleaner composition of Example A for 2 minutes at 55° C. with mild agitation. The panels were then immersed in a tap water rinse for 1 minute at ambient temperature with mild agitation followed by a 5-second cascading deionized water rinse. The panels were immersed in the deoxidizing composition of Example B for 1.5 minutes at ambient temperature followed by a 1-minute immersion rinse in tap water at ambient temperature and mild agitation followed by a 5-second cascading deionized water rinse. Subsequently, the panels were immersed in the conditioning composition of Example C for 2 minutes followed by a deionized water immersion rinse for 1 minute with intermittent agitation then a 5-second cascading deionized water rinse. The panels were then immersed in the pretreatment composition of Example E for 5 minutes at ambient temperature without agitation. After the pretreatment composition, the panels were rinsed in an immersion rinse in deionized water for 2 minutes at ambient temperature with intermittent agitation followed by a 5-second cascading deionized water rinse. The panels were air dried at ambient conditions overnight before testing.

One panel (Bralco) was placed in a neutral salt spray cabinet operated according to ASTM B117 for 1-day corrosion testing and one panel (Bralco) was placed in a neutral salt spray cabinet operated according to ASTM B117 for 7-day corrosion testing. An image of the panel following the 1-day corrosion testing is shown in FIG. 1(B) and an image of the panel following the 7-day corrosion testing is shown in FIG. 3(B). Corrosion performance was evaluated by either evaluating the percentage of the panel that was corroded or by counting the number of pits visible to the unaided eye on the panels. Data are reported in Tables 12 and 13. Corrosion performance also was analyzed using the macroscope described below. Data are reported in FIG. 2.

The remaining panel (Priority Metals) was analyzed to determine the concentration of the elements shown at various depths using XPS depth profiling. Data are shown in FIG. 4B. The XPS depth profile of the substrate treated according to Example 15 were generated using a Physical Electronics VersaProbe II instrument equipped with a monochromatic Al kα x-ray source (hν=1,486.7 eV) and a concentric hemispherical analyzer. Charge neutralization was performed using both low energy electrons (<5 eV) and argon ions. The binding energy axis was calibrated using sputter cleaned Cu foil (Cu 2p3/2=932.62 eV, Cu 2p3/2=75.1 eV) and Au foils (Au 4f7/2=83.96 eV). Peaks were charge referenced to CHx band in the carbon is spectra at 284.8 eV. Measurements were made at a takeoff angle of 45° with respect to the sample surface plane. This resulted in a typical sampling depth of 3-6 nm (95% of the signal originated from this depth or shallower). Quantification was done using instrumental relative sensitivity factors (RSFs) that account for the x-ray cross section and inelastic mean free path of the electrons. Ion sputtering was done using 4 kV Ar+ rastered over a 1.5 mm×1.5 mm area. The sputtering rate in the Al₂O₃ layer was 18 nm/min. These data confirm that magnesium was present in the treated substrate at its highest concentration in an amount of about 14 atomic % from the air/substrate surface interface to about 750 nm below the air/substrate surface interface, then steadily decreases to a concentration of less than 2 atomic % at about 2250 nm below the air/substrate surface interface.

### Example 16

Two aluminum 2024T3 bare substrate (Bralco Metals, La Mirada, Calif.) measuring 3″×5″×0.032″ were hand-wiped with methyl ethyl ketone (100%) and a disposable cloth and allowed to air dry prior to chemical cleaning. The panels were immersed in the cleaner composition of Example A for 2 minutes at 55° C. with mild agitation. The panels were then immersed in a tap water rinse for 1 minute at ambient temperature with mild agitation followed by a 5-second cascading deionized water rinse. The panels were immersed in the deoxidizing composition of Example B for 1.5 minutes at ambient temperature followed by a 1-minute immersion rinse in tap water at ambient temperature and mild agitation followed by a 5-second cascading deionized water rinse. Then, the panels were immersed in the conditioning composition of Example C for 2 minutes followed by a deionized water immersion rinse for 1 minute with intermittent agitation then a 5-second cascading deionized water rinse. The panel was then immersed in the pretreatment composition of Example E for 5 minutes at ambient temperature without agitation. Then, the panel was immersed in an immersion rinse in deionized water for 2 minutes at ambient temperature with intermittent agitation followed by a 5-second cascading deionized water rinse. The panel was then immersed in the pretreatment composition of Example I for 5 minutes at ambient temperature without agitation. Then, the panel was immersed in an immersion rinse in deionized water for 2 minutes at ambient temperature with intermittent agitation followed by a 5-second cascading deionized water rinse. The panel was air dried at ambient conditions overnight before testing.

One panel was placed in a neutral salt spray cabinet operated according to ASTM B117 for 1-day corrosion testing and one panel was placed in a neutral salt spray cabinet operated according to ASTM B117 for 7-day corrosion testing. An image of the panel following the 1-day corrosion testing is shown in FIG. 1(C) and an image of the panel following the 7-day corrosion testing is shown in FIG. 3(C). Corrosion performance was evaluated by either evaluating the percentage of the panel that was corroded or by counting the number of pits visible to the unaided eye on the panels. Data are reported in Tables 12 and 13. Corrosion performance also was analyzed using the macroscope described below. Data are reported in FIG. 2.

### Example 17

Two aluminum 2024T3 bare substrate (Bralco Metals, La Mirada, Calif.) measuring 3″×5″×0.032″ was hand-wiped with methyl ethyl ketone (100%) and a disposable cloth and allowed to air dry prior to chemical cleaning. The panels were immersed in the cleaner composition of Example A for 2 minutes at 55° C. with mild agitation. The panels were then immersed in a tap water rinse for 1 minute at ambient temperature with mild agitation followed by a 5-second cascading deionized water rinse. The panels were immersed in the deoxidizing composition of Example B for 1.5 minutes at ambient temperature followed by a 1-minute immersion rinse in tap water at ambient temperature and mild agitation followed by a 5-second cascading deionized water rinse. The panels were then immersed in the pretreatment composition of Example I for 5 minutes at ambient temperature without agitation. Then, the panels were immersed in an immersion rinse in deionized water for 2 minutes at ambient temperature with intermittent agitation followed by a 5-second cascading deionized water rinse. The panels were air dried at ambient conditions overnight before testing.

One panel was placed in a neutral salt spray cabinet operated according to ASTM B117 for 1-day corrosion testing and one panel was placed in a neutral salt spray cabinet operated according to ASTM B117 for 7-day corrosion testing. An image of the panel following the 1-day corrosion testing is shown in FIG. 1(D) and an image of the panel following the 7-day corrosion testing is shown in FIG. 3(D). Corrosion performance was evaluated by either evaluating the percentage of the panel that was corroded or by counting the number of pits visible to the unaided eye on the panels. Where panels had more than 15% surface corrosion, the number of pits could not be counted with the unaided eye. Data are reported in Tables 12 and 13. Corrosion performance also was analyzed using the macroscope described below. Data are reported in FIG. 2.

TABLE 12
Number of pits per panel in Experiments 14-17 following 1-day exposure
to neutral salt spray as evaluated using the unaided eye

| | Hydroxide | Magnesium | Rare Earth | Seal | # of |
|---|---|---|---|---|---|
| | Compo- | Pretreat- | Pretreat- | Compo- | Pits/% |
| | sition | ment | ment | sition | Corrosion |
| Example 14 | No | No | No | No | 30% |
| Example 15 | Yes | Yes | No | No | >100 |
| Example 16 | Yes | Yes | Yes | No | 25% |
| | | | | | corrosion |
| Example 17 | No | No | Yes | No | 30% |
| | | | | | corrosion |

TABLE 13
Number of pits per panel in Experiments 14-17 following 7-day exposure
to neutral salt spray as evaluated using the unaided eye

| | Hydroxide | Magnesium | Rare Earth | Seal | # of |
|---|---|---|---|---|---|
| | Compo- | Pretreat- | Pretreat- | Compo- | Pits/% |
| | sition | ment | ment | sition | Corrosion |
| Example 14 | No | No | No | No | 95% |
| Example 15 | Yes | Yes | No | No | >100 pits |
| Example 16 | Yes | Yes | Yes | No | 15% |
| | | | | | corrosion |
| Example 17 | No | No | Yes | No | 95% |
| | | | | | corrosion |

Panels from Examples 14-17 were analyzed using the unaided eye. If surface corrosion was less than 150, then pits were counted up to 100. If there were more than 100 pits on a panel, then the number of pits was recorded as >100 pits. If surface corrosion was 15% or more, then the % surface corrosion was recorded. The data in Tables 12 and 13 demonstrate that treatment of panels with the hydroxide-containing conditioner composition and the first pretreatment composition (containing magnesium) improves corrosion performance as demonstrated by the decrease in surface corrosion as shown by Example 15.

Panels from Examples 14-17 also were evaluated using a Keyence VR3200 3D Measuring Macroscope, which uses reflectometry to measure 3D surface topology through a non-contact, optical method. For each panel analyzed, surface topologies measuring 6.5 cm by 4.4 cm at a pixel resolution of 14.8 μm were acquired and baseline corrected using the software's built-in waveform removal tool with a strength of 10. Pits were characterized using the software's built-in Volume and Area analysis tool. Using this tool, all pits with a depth of greater than 3 μm and an area at the surface of larger than 10,000 μm\hat{ }2 (at 3 μm depth) were counted and summarized. Data are shown in FIG. 2.

As illustrated in FIG. 2, the panel treated according to Example 15 only had 4 pits as determined by the macroscope. The pits averaged approximately 10 μm deep and approximately 160 μm diameter. Dark spots seen in the optical image (FIG. 1(B)) were measured to be very superficial at this magnification and almost none of them exceeded the 3 μm threshold. The panel treated according to Example 16 had 81 pits and were an average of 13 μm deep and 150 μm diameter. The panels treated according to Examples 14 and 17 had 206 and 292 pits, respectively, and each averaged about 21 μm deep and about 200 μm diameter.

Whereas particular features of the present invention have been described above for purposes of illustration, it will be evident to those skilled in the art that numerous variations of the details of the coating composition, coating, and methods disclosed herein may be made without departing from the scope in the appended claims.

We claim:

1. A system for treating a metal substrate, comprising:
a conditioner composition comprising a hydroxide source; and
a first pretreatment composition comprising a magnesium element, a halide element, and an oxidizing agent.

2. The system of claim 1, wherein the conditioner composition has a pH of 9.0 to 13.5.

3. The system of claim 1, wherein the magnesium element and the halide element are derived from a single source.

4. The system of claim 1, wherein the magnesium element is derived from a first source and the halide element is derived from a second source.

5. The system of claim 1, wherein the magnesium element is present in the first pretreatment composition in an amount of 500 ppm to 6,000 ppm based on total weight of the first pretreatment composition.

6. The system of claim 1, wherein the halide element is present in the first pretreatment composition in an amount of 3000 ppm to 40,000 ppm based on total weight of the first pretreatment composition.

7. The system of claim 1, wherein the oxidizing agent is present in the first pretreatment composition in an amount of 100 ppm to 3,000 ppm based on total weight of the first pretreatment composition.

8. The system of claim 1, wherein the first pretreatment composition has a pH of 1.0 to 7.0.

9. The system of claim 1, further comprising a cleaning composition.

10. The system of claim 1, further comprising a deoxidizer.

11. The system of claim 1, further comprising a second pretreatment composition comprising a rare earth element.

12. The system of claim 11, wherein the rare earth element is present in the second pretreatment composition in an amount of 50 ppm to 500 ppm based on total weight of the second pretreatment composition.

13. The system of claim 1, further comprising a sealing composition comprising a lithium element.

14. The system of claim 13, wherein the lithium element is present in the sealing composition in an amount of 5 ppm to 5,500 ppm based on total weight of the sealing composition.

15. A substrate obtainable by the system of claim 1.

16. The substrate of claim 15, wherein the substrate has at least one of the following:
(a) a reduction in the number of pits (counted by the unaided eye) on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;
(b) a reduction in the percent of surface corrosion on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;
(c) a reduction in the number of pits (counted using a Keyence VR3200 3D Measuring Macroscope, counting pits with a depth of greater than 3 μm and an area at the surface of larger than 10,000 μm\hat{ }2 (at 3 μm depth)) on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day;
(d) a reduction in the percent of the substrate surface corrosion on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day; or
(e) at least 10 atomic % from the air/substrate surface interface to at least 750 nm below the air/substrate surface interface as measured by XPS depth profiling (using a Physical Electronics VersaProbe II instrument equipped with a monochromatic Al kα x-ray source (hν=1,486.7 eV) and a concentric hemispherical analyzer).

17. A method of treating a substrate, comprising:
contacting at least a portion of the substrate with a conditioner composition having a pH greater than 9.0; and
contacting at least a portion of the substrate contacted with the conditioner composition with a first pretreatment composition comprising a magnesium element, a halide element, and an oxidizing agent.

18. The method of claim 17, further comprising contacting at least a portion of the substrate contacted with the first pretreatment composition with a second pretreatment composition comprising a rare earth element.

19. The method of claim 18, further comprising contacting at least a portion of the substrate contacted with the second pretreatment composition with a sealing composition comprising a lithium element.

20. A substrate obtainable by the method of claim 17.

21. The substrate of claim 20, wherein the substrate has at least one of the following:
(a) a reduction in the number of pits (counted by the unaided eye) on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;
(b) a reduction in the percent of surface corrosion on a surface of the substrate following exposure to neutral salt spray testing (ASTM B117) for 7 days compared to a substrate not treated with the conditioner composition and the first pretreatment composition following exposure to neutral salt spray testing (ASTM B117) for 7 days;
(c) a reduction in the number of pits (counted using a Keyence VR3200 3D Measuring Macroscope, counting pits with a depth of greater than 3 μm and an area at the surface of larger than 10,000 μm\hat{ }2 (at 3 μm depth)) on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day;
(d) a reduction in the percent of the substrate surface corrosion on a surface of the substrate following exposure to neutral salt spray testing (ASTM B117) for 1 day compared to a substrate not treated with the conditioner composition and the first pretreatment composition following exposure to neutral salt spray testing (ASTM B117) for 1 day; or
(e) at least 10 atomic % from the air/substrate surface interface to at least 750 nm below the air/substrate surface interface as measured by XPS depth profiling (using a Physical Electronics VersaProbe II instrument equipped with a monochromatic Al kα x-ray source (hν=1,486.7 eV) and a concentric hemispherical analyzer).
